(19) United States
(12) Patent Application Publication
(10) Pub. No.: US 2026/0241345 A1
(43) Pub. Date: Aug. 20, 2026

(54) ULTRAFILTRATION MEMBRANE FOR EMULSION SEPARATION

(71) Applicant: King Fahd University of Petroleum and Minerals, Dhahran (SA)

(72) Inventors: Umair BAIG, Dhahran (SA); Abdul WAHEED, Dhahran (SA); Isam H. ALJUNDI, Dhahran (SA)

(73) Assignee: King Fahd University of Petroleum and Minerals, Dhahran (SA)

(21) Appl. No.: 19/058,121

(22) Filed: Feb. 20, 2025

(51) Int. Cl. B01D 69/14; B01D 61/14; B01D 67/00; B01D 69/10; B01D 71/02; B01D 71/56; C02F 1/44; C02F 101/32

(52) U.S. Cl. CPC B01D 69/14111; B01D 61/145; B01D 67/00793; B01D 69/107; B01D 71/0271; B01D 71/56; C02F 1/444; C02F 2101/32

(57) ABSTRACT

An ultrafiltration membrane comprising: a microporous support layer including polyvinylidene fluoride; and, an active layer disposed on and in the support layer. The active layer comprises a polyamide matrix in which are dispersed nanoparticles of strontium titanate (SrTiO₃) which have been functionalized with an amino-functional alkoxysilane. The nanoparticles of strontium titanate are covalently bonded to the polyamide matrix, and the polyamide matrix is obtained by the polycondensation reaction of a C₂-C₆ alkylene diamine and an aromatic dicarboxylic acid or a reactive derivative thereof.

### STATEMENT OF ACKNOWLEDGEMENT

The support of the Interdisciplinary Center for Membranes and Water Security through Project #INMW2406, King Fahd University of Petroleum and Minerals (KFUPM) is gratefully acknowledged.

### STATEMENT OF PRIOR DISCLOSURE BY INVENTOR

Aspects of the present disclosure are described in Baig et al. “Exploring the potential of perovskite structured SrTiO₃ ceramics nanoparticles for developing SrTiO₃ ceramics-decorated advanced Super-Wettable and photocatalytic self-cleaning membrane and its applications”, Ceramics International, Vol. 50: 22, Part C: 48280-48292, 2024, incorporated herein by reference in its entirety.

### BACKGROUND

### Technical Field

The present disclosure is directed towards filtration techniques for emulsion separation, and, more particularly, relates to an ultrafiltration membrane and a method of production thereof.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

With the advent of civilization and industrialization, global energy demand has increased exponentially. Fossil fuels—oil and gas—have been at the forefront of meeting the global demand for energy. However, as a result of their use, oil spillages and the release of oily wastewater from industrial zones and from domestic households pollute aquatic ecosystems and endanger marine and freshwater life and, eventually, human beings. Among the different industries that discharge oily wastewater as effluent, the oil and gas industries release abundant quantities of such oily wastewater in the form of oil-in-water (O/W) emulsions. The treatment of such a complex and challenging streams is of enormous importance because it may provide multiple beneficial outcomes for industry, government and society; importantly, it may promote sustainability and the conservation of aquatic ecosystems. An efficient treatment of such a wastewater stream may convert the wastewater into a useful clean water source that can be reused or discharged safely into the aquatic environment [See: Tortajada, C. Contributions of recycled wastewater to clean water and sanitation sustainable development goals, Clean Water 2020 3:1 3, 1-6 (2020)].

Several wastewater treatment technologies have been widely used in treating oily wastewater released as O/W emulsions from petrochemical industries [See: Adetunji, A. I. et al. Treatment of industrial oily wastewater by advanced technologies: A review, Appl Water Sci 11, 1-19 (2021)]. Well-known processes include electro-coagulation, biological wastewater treatment, and API separators. The common aim of these processes is to reduce chemical oxygen demand (COD), biological oxygen demand (BOD) and total petroleum hydrocarbons (TPHs) of the wastewater.

Although some success has been achieved in treating oily wastewater streams, a need is considered to remain to develop efficient and cost-effective solutions for removing pollutants—such as emulsified oil/dissolved oil—from oily wastewater streams. The further development of membranes for treating a variety of wastewater streams may be important for the wastewater treatment industry in this context. Membrane-based separations are advantageous, compared to other water treatment technologies, as they may have lower energy consumption, may possess tunable chemistry and may have easily modified physical structures.

For a membrane to be effective in O/W emulsion separation, the membrane surface must be superhydrophobic [See: Chen, L., et al., Suppression of membrane fouling in emulsion separation through a covalently grafted liquid-like layer, Sep. Purif Technol. 338, 126562 (2024)]. The underwater superhydrophobic surface of the membrane develops a strong hydration layer on its surface which may not allow the oil to wet the membrane surface. Since the oil does not come in contact with the membrane surface, water is readily permitted through the membrane under filtration conditions. Furthermore, this superhydrophobic property reduces the possibility of membrane fouling owing to the repulsion of the oil by the hydration layer present on the top of the membrane.

Researchers have explored different strategies for developing membranes with these special surface wettability features. The fabrication of a stainless steel mesh membrane coated with carbon nanoparticles which was in turn coated with hydrophilic silica (SiO₂) particles has been reported [See: Liu, D., et al., Selective separation of oil and water with special wettability mesh membranes, RSC Adv. 7, 12908-12915 (2017)]. The SiO₂/carbon stainless steel mesh was modified further in two ways. In the first approach, 1H,1H,2H,2H-perfluorooctyltrichlorosilane (PFOTS) was applied to the SiO₂/carbon stainless steel mesh, while in the second approach, poly(diallyldimethylammonium-perfluorooctonoate) (PDDA-PFO) was applied to the SiO₂/carbon stainless steel mesh. The PFOTS decorated membrane exhibited superhydrophobic/super oleophilic wettability whereas the PDDA-PFO membrane exhibited super hydrophilic/oleophobic surface features. The obtained stainless steel mesh membranes were able to separate an oil-in-water (O/W) emulsion with a separation efficiency of 97% and a permeate flux of 930 L m⁻² h⁻¹. Although this approach highlights the importance of chemistry in tuning the surface wettability of the membranes, the deposition of different layers such as carbon and SiO₂ is merely governed by physical or weak secondary interactions. Furthermore, the mesh membranes may not have utility in industrial operations given that the separation of the oil-in-water (O/W) emulsion was carried out under gravity filtration: such filtration can be challenging for treating the immense volumes of oily wastewater streams released from the petroleum industry [See: Park, J. E. et al., A facile method for separating fine water droplets dispersed in oil through a pre-wetted mesh membrane, iScience 27, 109556 (2024)]. On this basis, there arises a requirement for a more efficient and effective membrane with special wettability, and controlled pore size that may offer high separation efficiency, excellent permeate flux, and lower fouling tendency during filtration conditions. Moreover, the membrane structure should be stable enough to perform under crossflow filtration mode.

Accordingly, one object of the present disclosure is to provide an ultrafiltration membrane and a method of preparation thereof, that may circumvent the drawbacks and limitations, such as, high cost, low operational inefficiency, poor sustainability, low reusability, quick fouling, and low yield, of the materials known in the art.

### SUMMARY

In an exemplary embodiment, an ultrafiltration membrane is described. The ultrafiltration membrane comprises a microporous support layer including polyvinylidene fluoride, and an active layer disposed on and in the support layer. The active layer comprises a polyamide matrix in which are dispersed nanoparticles of strontium titanate (SrTiO₃) which have been functionalized with an amino-functional alkoxysilane. The nanoparticles of strontium titanate are covalently bonded to the polyamide matrix, and the polyamide matrix is obtained by the polycondensation reaction of a C₂-C₆ alkylene diamine and an aromatic dicarboxylic acid or a reactive derivative thereof.

In some embodiments, the active layer wholly covers the microporous support layer.

In some embodiments, the ultrafiltration membrane comprises agglomerates of rounded functionalized nanoparticles of strontium titanate (SrTiO₃).

In some embodiments, at least a fraction of the nanoparticles of strontium titanate (SrTiO₃) are uniformly functionalized across their surfaces by the amino-functional alkoxysilane, as demonstrated by energy-dispersive X-ray spectroscopy (EDS).

In some embodiments, the nanoparticles of strontium titanate (SrTiO₃) have a median volume particle size (Dv50) of from about 20 nm to about 100 nm, as determined by transmission electron microscopy (TEM).

In some embodiments, the nanoparticles of strontium titanate (SrTiO₃) have a median volume particle size (Dv50) of from about 40 nm to about 60 nm, as determined by transmission electron microscopy.

In some embodiments, the amino-functional alkoxysilane has the general formula:

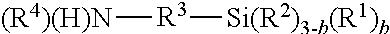

where: R¹ is C₁-C₆ alkyl; R² is C₁-C₆ alkyl; R³ is C₁-C₁₂ alkylene; R⁴ is H or C₁-C₆ alkyl; and, b is 1, 2 or 3.

In some embodiments of the general formula as mentioned above: R¹ is C₁-C₂ alkyl; R² is C₁-C₂ alkyl; R³ is C₁-C₄ alkylene; R⁴ is H; and, b is 2 or 3.

In some embodiments, the amino-functional alkoxysilane is selected from the group consisting of 3-aminopropyltrimethoxysilane; 3-aminopropyltriethoxysilane; 3-aminopropyldimethoxymethylsilane; and 3-aminopropyldimethoxymethylsilane.

In some embodiments, the polyamide matrix is obtained by the polycondensation reaction of a C₂-C₆ alkylene diamine with isophthalic acid, terephthalic acid or a reactive derivative thereof.

In some embodiments, the polyamide matrix is obtained by the polycondensation reaction of a C₂-C₄ alkylene diamine with isophthalic acid, terephthalic acid or a reactive derivative thereof.

In some embodiments, the polyamide matrix is obtained by the polycondensation reaction of ethylene diamine with isophthalic acid or a reactive derivative thereof.

In some embodiments, the ultrafiltration membrane has: a water contact angle in air (θ_{w,a}) of about 65° to about 75°; an oil contact angle in air (θ_{o,a}) of about 0° to about 10°; and, an oil contact angle in water (θ_{o,w}) of from about 155° to about 165°.

In some embodiments, the ultrafiltration membrane has a flux of at least 50 L m⁻²h⁻¹, as determined at about 100 kPa and about 25° C. in accordance with ASTM D5090-20.

In some embodiments, the ultrafiltration membrane has a flux of from about 50 to about 400 L m⁻²h⁻¹, as determined at about 200 kPa and about 25° C. in accordance with ASTM D5090-20.

In another exemplary embodiment, a method of preparing the ultrafiltration membrane is described. The method comprises: contacting, for a duration of from about 10 to about 100 hours, the amino-functional alkoxysilane with a dispersion of SrTiO₃ nanoparticles in a polar protic solvent; and, separating the SrTiO₃ nanoparticles functionalized with said amino-functional alkoxysilane from the dispersion. The method further comprises forming the polyamide matrix by the polycondensation reaction of the C₂-C₆ alkylene diamine and the aromatic dicarboxylic acid or reactive derivative thereof. The polycondensation reaction is performed in the presence of the functionalized SrTiO₃ nanoparticles and at an interfacial surface of the microporous support layer including polyvinylidene fluoride.

In some embodiments, the method of preparing the ultrafiltration membrane further comprises, prior to the polycondensation reaction, impregnating the microporous polyvinylidene support layer with a fraction of the reactant C₂-C₆ alkylene diamine, and disposing at least a fraction of the functionalized SrTiO₃ nanoparticles on the interfacial surface of the microporous support layer comprising polyvinylidene fluoride.

In yet another exemplary embodiment, an ultrafiltration method is described. The method comprises: flowing an oil-in-water emulsion through the ultrafiltration membrane as defined above; and, collecting the permeate.

In some embodiments, the oil-in-water emulsion includes from about 10 parts per million (ppm) by weight of oil to about 250 ppm by weight of oil.

In some embodiments, the method comprises a transmembrane pressure differential of from about 50 kPa to about 200 kPa.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary flow chart depicting a method of preparing an ultrafiltration membrane, according to certain embodiments.

FIG. 1B is an exemplary scheme depicting the fabrication process of a polyvinylidene fluoride (PVDF) ultrafiltration (UF) support, according to certain embodiments.

FIG. 1C is an exemplary scheme depicting a fabrication route for a polyamide active layer containing amino-functionalized strontium titanate membrane on a PVDF support (F—SrTiO₃/PA@PVDF), according to certain embodiments.

FIG. 2A depicts an exemplary chemical reaction for amino-functionalization of SrTiO₃ nanoparticles, according to certain embodiments.

FIG. 2B depicts an exemplary interfacial polymerization reaction for synthesizing a F—SrTiO₃/PA active layer, according to certain embodiments.

FIG. 3A is a Fourier transform infrared (FTIR) spectra of SrTiO₃ and F—SrTiO₃, according to certain embodiments.

FIG. 3B is a Fourier transform infrared (FTIR) spectra of SrTiO₃ and F—SrTiO₃, according to certain embodiments.

FIG. 3C is a graph depicting the powder X-ray diffraction (PXRD) pattern for SrTiO₃ and F—SrTiO₃, according to certain embodiments.

FIG. 4A is an image depicting the field emission transmission electron microscopy (FE-TEM) results for SrTiO₃, at a resolution of 200 nanometers (nm), according to certain embodiments.

FIG. 4B is an image depicting FE-TEM results for SrTiO₃, at a resolution of 20 nm, according to certain embodiments.

FIG. 4C is an image depicting a selected area electron diffraction (SAED) pattern of SrTiO₃, according to certain embodiments.

FIG. 4D is an image depicting FE-TEM results for F—SrTiO₃, at a resolution of 200 nm, according to certain embodiments.

FIG. 4E is an image depicting FE-TEM results for F—SrTiO₃, at a resolution of 20 nm, according to certain embodiments.

FIG. 4F is an image depicting the SAED pattern of F—SrTiO₃, according to certain embodiments.

FIG. 5A depicts scanning electron microscopy (SEM) micrographs of SrTiO₃, at a resolution of 10 micrometers (μm), according to certain embodiments.

FIG. 5B depicts SEM micrographs of SrTiO₃, at a resolution of 1 μm, according to certain embodiments.

FIG. 5C is a graph depicting the energy dispersive X-ray (EDX) analysis of SrTiO₃, according to certain embodiments.

FIG. 5D depicts the elemental mapping analysis of the SrTiO₃, showing a presence of strontium (Sr), according to certain embodiments.

FIG. 5E depicts the elemental mapping analysis of the SrTiO₃, showing a presence of titanium (Ti), according to certain embodiments.

FIG. 5F depicts the elemental mapping analysis of the SrTiO₃, showing a presence of oxygen (O), according to certain embodiments.

FIG. 5G depicts the SEM micrographs of F—SrTiO₃, at a resolution of 10 μm, according to certain embodiments.

FIG. 5H depicts the SEM micrographs of F—SrTiO₃, at a resolution of 1 μm, according to certain embodiments.

FIG. 5I is a graph depicting the EDX analysis of F—SrTiO₃, according to certain embodiments.

FIG. 5J depicts the elemental mapping analysis of the F—SrTiO₃, showing a presence of Sr, according to certain embodiments.

FIG. 5K depicts the elemental mapping analysis of the F—SrTiO₃, showing a presence of silicon (Si), according to certain embodiments.

FIG. 5L depicts the elemental mapping analysis of the F—SrTiO₃, showing a presence of Ti, according to certain embodiments.

FIG. 5M depicts the elemental mapping analysis of the F—SrTiO₃, showing a presence of oxygen (O), according to certain embodiments.

FIG. 5N depicts the elemental mapping analysis of the F—SrTiO₃, showing a presence of carbon (C), according to certain embodiments.

FIG. 5O depicts the elemental mapping analysis of the F—SrTiO₃, showing a presence of nitrogen (N), according to certain embodiments.

FIG. 6A is a graph depicting the FTIR spectra for the PVDF support and the F—SrTiO₃/PA@PVDF membrane, according to certain embodiments.

FIG. 6B is a graph depicting a fingerprint region of the FTIR spectra for the PVDF support and the F—SrTiO₃/PA@PVDF membrane, according to certain embodiments.

FIG. 6C is a graph depicting the PXRD patterns of the PVDF support and the F—SrTiO₃/PA@PVDF membrane, according to certain embodiments.

FIG. 7A is an optical image depicting the SEM micrograph for the PVDF support, at a resolution of 50 μm, according to certain embodiments.

FIG. 7B is an optical image depicting the SEM micrograph for the PVDF support, at a resolution of 10 μm, according to certain embodiments.

FIG. 7C is an optical image depicting the SEM micrograph for the PVDF support, at a resolution of 5 μm, according to certain embodiments.

FIG. 7D is an optical image depicting the SEM micrograph for the F—SrTiO₃/PA@PVDF membrane, at a resolution of 50 μm, according to certain embodiments.

FIG. 7E is an optical image depicting the SEM micrograph for the F—SrTiO₃/PA@PVDF membrane, at a resolution of 10 μm, according to certain embodiments.

FIG. 7F is an optical image depicting the SEM micrograph for the F—SrTiO₃/PA@PVDF membrane, at a resolution of 5 μm, according to certain embodiments.

FIG. 8A is an optical image depicting a cross-sectional SEM micrograph for the PVDF support, at a resolution of 50 μm, according to certain embodiments.

FIG. 8B is an optical image depicting the cross-sectional SEM micrograph for the PVDF support, at a resolution of 10 μm, according to certain embodiments.

FIG. 8C is an optical image depicting the cross-sectional SEM micrograph for the PVDF support, at a resolution of 10 μm, according to certain embodiments.

FIG. 8D is an optical image depicting the cross-sectional SEM micrograph for the F—SrTiO₃/PA@PVDF membrane, at a magnification of 50 μm, according to certain embodiments.

FIG. 8E is an optical image depicting the cross-sectional SEM micrograph for the F—SrTiO₃/PA@PVDF membrane, at a resolution of 10 μm, according to certain embodiments.

FIG. 8F is an optical image depicting the cross-sectional SEM micrograph for the F—SrTiO₃/PA@PVDF membrane, at a resolution of 10 μm, according to certain embodiments.

FIG. 9A is a mapping analysis of the PVDF support, depicting the presence of fluorine (F), according to certain embodiments.

FIG. 9B is a mapping analysis of the PVDF support, depicting the presence of carbon (C), according to certain embodiments.

FIG. 9C is a mapping analysis of the F—SrTiO₃/PA@PVDF membrane, depicting the presence of fluorine (F), according to certain embodiments.

FIG. 9D is a mapping analysis of the F—SrTiO₃/PA@PVDF membrane, depicting the presence of carbon (C), according to certain embodiments.

FIG. 9E is a mapping analysis of the F—SrTiO₃/PA@PVDF membrane, depicting the presence of strontium (Sr), according to certain embodiments.

FIG. 9F is a mapping analysis of the F—SrTiO₃/PA@PVDF membrane, depicting the presence of oxygen (O), according to certain embodiments.

FIG. 9G is a mapping analysis of the F—SrTiO₃/PA@PVDF membrane, depicting the presence of silicon (Si), according to certain embodiments.

FIG. 9H is a mapping analysis of the F—SrTiO₃/PA@PVDF membrane, depicting the presence of titanium (Ti), according to certain embodiments.

FIG. 9I is a mapping analysis of the F—SrTiO₃/PA@PVDF membrane, depicting the presence of nitrogen (N), according to certain embodiments.

FIG. 10A depicts a plurality of contact angle measurements in various ambient environments including air and water, for oil and water of the F—SrTiO₃/PA@PVDF membrane, according to certain embodiments.

FIG. 10B is a graph depicting the effect of increasing transmembrane pressure on permeate flux of the F—SrTiO₃/PA@PVDF membrane, according to certain embodiments.

FIG. 10C is a graph depicting the effect of oil concentration in the feed on permeate flux of the F—SrTiO₃/PA@PVDF membrane, according to certain embodiments.

FIG. 10D is a graph depicting the effect of oil concentration in the feed on separation efficiency of the F—SrTiO₃/PA@PVDF membrane, according to certain embodiments.

FIG. 11A is a graph depicting the effect of fouling and photocatalytic self-cleaning cycles on the reusability and stability of F—SrTiO₃/PA@PVDF membrane, in terms of variation in permeate flux, using a 200 parts per million (ppm) concentration oil-in-water (O/W) emulsion at a pressure of about 1 bar, according to certain embodiments.

FIG. 11B is a graph depicting the effect of fouling and photocatalytic self-cleaning cycles on the reusability and stability of F—SrTiO₃/PA@PVDF membrane, in terms of variation in separation efficiency, using a 200-ppm concentration oil-in-water (O/W) emulsion at a pressure of about 1 bar, according to certain embodiments.

FIG. 12A is a microscopic image of 50 ppm oil-in-water (O/W) emulsion feed, according to certain embodiments.

FIG. 12B is an optical image of 50 ppm oil-in-water (O/W) emulsion feed and a resultant permeate thereof post processing through the ultrafiltration membrane, according to certain embodiments.

FIG. 12C is a microscopic image of a permeate of the 50 ppm oil-in-water (O/W) emulsion feed, post processing through the ultrafiltration membrane, according to certain embodiments.

FIG. 12D is a microscopic image of 100 ppm oil-in-water (O/W) emulsion, according to certain embodiments.

FIG. 12E is an optical image of 100 ppm oil-in-water (O/W) emulsion feed and a resultant permeate thereof post processing through the ultrafiltration membrane, according to certain embodiments.

FIG. 12F is a microscopic image of a permeate of the 100 ppm oil-in-water (O/W) emulsion feed, post processing through the ultrafiltration membrane, according to certain embodiments.

FIG. 12G is a microscopic image of 200 ppm oil-in-water (O/W) emulsion, according to certain embodiments.

FIG. 12H is an optical image of 200 ppm oil-in-water (O/W) emulsion feed and a resultant permeate thereof post processing through the ultrafiltration membrane, according to certain embodiments.

FIG. 12I is a microscopic image of a permeate of the 200 ppm oil-in-water (O/W) emulsion feed, post processing through the ultrafiltration membrane, according to certain embodiments.

FIG. 13A is an exemplary mechanism for oil-in-water (O/W) emulsions separation using the F—SrTiO₃/PA@PVDF membrane, according to certain embodiments.

FIG. 13B is an exemplary mechanism for the photo-catalytic self-cleaning process to clean/recover the fouled F—SrTiO₃/PA@PVDF membrane post oil-in-water (O/W) emulsion separation, according to certain embodiments.

### DETAILED DESCRIPTION

As used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The temperature parameters in the present application, if not specifically limited, are both allowed to be constant temperature processing and also allowed to be varied within a certain temperature interval. It should be understood that the constant temperature processing allows the temperature to fluctuate within the precision range of the instrument control. It is allowed to fluctuate in the range of, for example, 5° C., 4° C., 3° C., 2° C., or 1° C.

The term ‘fraction’ as used herein refers to a numerical quantity which defines a part up to but not including 100 percent or the entirety of the thing in question. The term “at least a fraction” is used to denote an amount up to and including 100 percent or the entirety of the thing in question.

As used herein, number average molecular weight (Mn) and weight average molecular weight (Mw) are determined by gel permeation chromatography (GPC) with tetrahydrofuran (THF) as the eluent in accordance with DIN 55672-1:2007-08. The term polydispersity (PD) is derived from Mw and Mn and is calculated as (Mw/Mn).

As used herein, the term ‘particle’ refers to a small object that acts as a whole unit with regard to its transport and properties.

As used herein, the term ‘nanoparticles (NPs)’ refers to particles having a particle size of 1 nanometer (nm) to 500 nm within the scope of the present invention.

It is envisaged that particles having utility herein may be fibrous, acicular, spherical, ellipsoidal, cylindrical, bead-like, cubic or platelet-like may be present alone or in combination. Moreover, it is envisaged that agglomerates of particles having the same or different morphologies may be present in the activated carbon.

Unless otherwise stated, the term “particle size” refers to the largest axis of the particle. In the case of a generally spherical particle, the largest axis is the diameter.

The term “median volume particle size” (Dv50), as used herein, refers to a particle size corresponding to 50% of the volume of the sampled particles being greater than and 50% of the volume of the sampled particles being smaller than the recited Dv50 value. Particle size is determined herein by Transmission Electron Microscopy (TEM).

The term “polar solvent” as used herein refers to a solvent having a dielectric constant (e) of more than 5 as measured at 25° C. The determination of dielectric constant (e) is known in the art: the use of measured voltages across parallel plate capacitors in such determinations may be mentioned. The term “polar solvent” may encompass both aprotic and protic solvents, wherein protic solvents are those solvents which are capable of yielding or accepting a proton and aprotic solvents are those solvents that do not yield or accept a proton.

The “acid value” or “acid number” is a measure of the amount of free acid present in a compound: the acid value is the number of milligrams of potassium hydroxide required for the neutralization of free acid present in one gram of a substance (mg KOH/g). Any measured acid values given herein have been determined in accordance with German Standard DIN 53402.

The “amine value” given herein is obtainable by titration with 0.1 N hydrochloric acid—in accordance with ASTM D2572-91—and thereafter calculated back to mg KOH/g.

The term “dried” as used herein means comprising less than 5 wt. % of any compound or composition being in liquid form when measured at 25° C. under ambient conditions. For instance, the term “dry” includes comprising less than 3 wt. %, less than 2 wt. %, less than 1%, or even about 0% of said compound or composition being in liquid form when measured at 25° C. under ambient conditions. Exemplary such compounds or compositions include water, oils, organic solvents and other wetting agents.

As used herein, the term ‘membrane’ refers to a porous structure that is capable of separating components of a homogeneous or heterogeneous fluid. In particular, ‘pores’ in the sense of the present disclosure indicate voids allowing fluid communication between different sides of the structure. More particular in use when a homogeneous or heterogeneous fluid is passed through the membrane, some components of the fluid can pass through the pores of the membrane into a ‘permeate stream’, some components of the fluid can be retained by the membrane and can thus accumulate in a ‘retentate’ and/or some components of the fluid can be rejected by the membrane into a ‘rejection stream’. It is not precluded in the present disclosure that both the retenate and the permeate can constitute valuable materials that can be subject to further processing, if required.

Membranes can be of various thicknesses, with homogeneous or heterogeneous structures. Membranes of the present disclosure can be in the form of flat sheets or bundles of hollow fibers. Membranes can also be in various configurations, including but not limited to spiral wound, tubular, hollow fiber, and other configurations identifiable to a skilled person upon a reading of the present disclosure. The membranes of the present disclosure are neutral or uncharged, and particle transport is considered to be passive, which passive transport can be facilitated by pressure, concentration, and chemical or electrical gradients of the ultrafiltration process.

As used herein, the term ‘filtration’ refers to a mechanical or physical operation that can be employed for the separation of constituents of homogeneous or heterogeneous solutions. Types of filtration can be categorized based on the estimated sizes of chemicals to be separated and can involve particle filtration (>10 micrometer (μm)); microfiltration (0.1-10 μm); ultrafiltration (0.01-0.1 μm); nanofiltration (NF) (0.001-0.01 μm); and, reverse osmosis, or RO (<0.001 μm).

As used herein, the term ‘permeate’ refers to a filtered liquid that passes through a membrane during a filtration process, leaving behind larger particles or contaminants.

The term ‘shear rate’ as used herein, references the rate of increase in the velocity of a fluid flowing in the x direction per unit distance in the orthogonal y direction. The shear rate has units of reciprocal time (s⁻¹).

As used herein, the term ‘flux’ refers to a metric for comparing, scaling, and assessing the general performance of a membrane. It is defined as the permeate flow per unit of time and membrane surface area, commonly expressed as lumens per square meter per hour (Lm⁻²h⁻¹). The flux indicates the efficiency and performance of the membrane in separating components from a liquid: high flux generally indicates a more efficient membrane capable of processing greater volumes of fluid.

The term “reactive derivative” used with respect to the aromatic dicarboxylic acid encompasses: the corresponding acid halides, in particular the acid chloride, acid bromide or acid iodide; acid anhydrides, including mixed acid anhydrides; and, reactive esters, in particular C₁-C₄ alkyl esters. Acid halides may be obtained, for example, by reaction of a salt of the acid with an halogenating agent, such as oxalyl chloride, thionyl chloride or thionyl bromide. An anhydride with, for instance, a (C₁-C₄)alkanoic acid or a hemi(C₁-C₄)alkyl carbonate may be obtained, respectively, by reaction of a salt of the said acid with an appropriate alkanoyl halide or a (C₁-C₄)alkyl chloroformate. In an exemplary embodiment, the reactive derivative in an acid halide, in particular an acid chloride.

As used herein, the term “polycondensation reaction” refers to a type of chemical reaction in which monomers with two or more reactive functional groups combine to form a polymer, releasing small molecules such as water or methanol as by-products. This reaction is commonly used in the synthesis of polyesters, polyamides, and other types of polymers.

As used herein, the term “polyamide matrix” refers to a network or structure formed by polyamide polymers, which are characterized by repeating amide bonds (—CONH—) within their chains. This matrix serves as a solid foundation or framework in materials, such as ultrafiltration membranes, providing mechanical strength, chemical stability, and resistance to degradation under various conditions.

As used herein, the term “water contact angle in air” refers to the angle formed between the surface of a solid and the tangent to the surface of a droplet of water placed on that solid surface, measured in the air. This angle is an indicator of the surface's wettability; a high contact angle (typically greater than 90°) indicates hydrophobicity, while a low contact angle (less than 90°) indicates hydrophilicity. It is commonly used to assess the surface properties of materials, including ultrafiltration membranes.

As used herein, the term “oil contact angle in air” refers to the angle formed between the surface of a solid and the tangent to the surface of a droplet of oil placed on that solid surface, measured in the air. This angle is used to characterize the interaction between the surface and oil; a high contact angle indicates a hydrophobic or oleophobic surface, while a low contact angle suggests a more oil-affinitive or oleophilic surface. It is an important parameter in evaluating the performance of materials, particularly in applications involving oil-water separation.

As used herein, the term “oil contact angle in water” refers to the angle formed between the surface of a solid and the tangent to the surface of a droplet of oil when it is placed on that solid surface submerged in water. This angle measures the interaction between the surface and oil in an aqueous environment. It is used to assess the oil-repellent or oil-affinitive nature of a surface, providing insight into the material's performance in oil-water separation applications or in environments where both oil and water are present.

As used herein, the term “oil-in-water emulsion” (O/W) refers to a dispersion of oil droplets within a continuous water phase. In this system, oil acts as the dispersed phase, and water is the continuous phase. Oil-in-water emulsions are commonly used in various industries, including food, cosmetics, pharmaceuticals, and water treatment, due to their stability and ability to efficiently carry and deliver hydrophobic substances while maintaining a water-based medium.

It is noted that references in the specification to “an embodiment”, “some embodiments”, “other embodiments” or the like indicate that the embodiment(s) described may include a particular feature, structure, or characteristic, but every embodiment may not necessarily include that particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement the described embodiment(s).

Aspects of this disclosure pertain to an ultrafiltration membrane with tailored properties, enhancing filtration performance. The present disclosure offers improved control over membrane characteristics, ensuring optimal separation and higher flux rates for various applications.

According to a first aspect of the present disclosure, an ultrafiltration membrane is described. The ultrafiltration membrane includes a microporous support layer, including polyvinylidene fluoride, and an active layer disposed on and in the support layer. In some embodiments, the active layer at least partially and more preferably wholly covers the microporous support layer. In certain embodiments, the active layer covers at least about 50%, about 55%, about 60%, about 65%, about 70%, about 75%, about 80%, about 85%, about 90°/or about 95% of the surface area of the microporous support layer.

The active layer includes a polyamide matrix. The polyamide matrix is obtained by the polycondensation reaction of a C₂-C₆ alkylene diamine and an aromatic dicarboxylic acid or a reactive derivative thereof.

Exemplary reactive C₂-C₆ alkylene diamines include, but are not limited to, propanediamine, 1,2-diaminopropane, 1,3-diaminopropane, butanediamine, 1,2-diaminobutane, 1,3-diaminobutane, 1,4-diaminobutane, pentanediamine, 1,2-diaminopentane, 1,3-diaminopentane, 1,4-diaminopentane, 1,5-diaminopentane, hexanediamine, 1,2-diaminohexane, 1,3-diaminohexane, 1,4-diaminohexane, 1,5-diaminohexane, 1,6-diaminohexane, 2-methyl-1,5-pentanediamine, and 2,2-dimethyl-1,3-propanediamine. A preference may be noted for the use of C₂-C₄ alkylene diamines. In a particularly preferred embodiment, the C₂-C₆ alkylene diamine is ethylenediamine.

Exemplary aromatic dicarboxylic acids may include, but are not limited to, terephthalic acid, phthalic acid, trimellitic acid, hemimellitic acid, pyromellitic acid, benzenedicarboxylic acid, naphthalene-1,4-dicarboxylic acid, naphthalene-2,6-dicarboxylic acid, anthracene-1,9-dicarboxylic acid, anthracene-2,6-dicarboxylic acid, biphenyl-4,4′-dicarboxylic acid, biphenyl-3,3′-dicarboxylic acid, diphenic acid, 4,4′-stilbenedicarboxylic acid, cinnamic acid dimer, coumarin dicarboxylic acid, quinoline dicarboxylic acid, pyridine-2,6-dicarboxylic acid, pyridine-3,5-dicarboxylic acid, quinoxaline-2,3-dicarboxylic acid, phenanthrene-9,10-dicarboxylic acid, 1,2-bis(4-carboxyphenyl)ethane, perylene-3,4-dicarboxylic acid, perylene-1,12-dicarboxylic acid, 2,5-thiophenedicarboxylic acid, 3,4-thiophenedicarboxylic acid, benzothiophene-2,3-dicarboxylic acid, benzofuran-2,3-dicarboxylic acid, and carbazole-1,3-dicarboxylic acid. A preference may be noted for the use of isophthalic acid or terephthalic acid. In a particularly preferred embodiment, the aromatic dicarboxylic acid is isophthalic acid.

In some embodiment, the polyamide matrix is obtained by the polycondensation reaction of a C₂-C₆ alkylene diamine and an aromatic dicarboxylic acid or a reactive derivative thereof. In some embodiments, the polyamide matrix is obtained by the polycondensation reaction of a C₂-C₆ alkylene diamine with isophthalic acid, terephthalic acid or a reactive derivative thereof. In some embodiments, the polyamide matrix is obtained by the polycondensation reaction of a C₂-C₄ alkylene diamine with isophthalic acid, terephthalic acid or a reactive derivative thereof. In a preferred embodiment, the polyamide matrix is obtained by the polycondensation reaction of ethylene diamine with isophthalic acid or a reactive derivative thereof.

In the polyamide matrix are dispersed nanoparticles of strontium titanate. The nanoparticles of strontium titanate are covalently bonded to the polyamide matrix. The morphology of the strontium titanate nanoparticles is not particularly limited. It is envisaged that nanoparticles which are fibrous, acicular, spherical, ellipsoidal, cylindrical, bead-like, cubic or platelet-like may be present alone or in combination. Moreover, it is envisaged that agglomerates of nanoparticles having the same or different morphologies may be present in the nanocomposite. In an embodiment, however, the strontium titanate may be in the form of substantially spherical nanoparticles, granular nanoparticles, cuboidal nanoparticles or aggregates thereof. In a specific embodiment, the ultrafiltration membrane includes agglomerates of rounded functionalized nanoparticles of strontium titanate. In present disclosure, the SrTiO₃ nanoparticles appeared to have a square to irregular shape resembling rocks.

In some embodiments, the nanoparticles of strontium titanate have a median volume particle size (Dv50) ranging from about 20 to about 100 nm, for example, from about 40 to about 60 nm, about 20-25 nm, about 26-30 nm, about 31-35 nm, about 36-40 nm, about 41-45 nm, about 46-50 nm, about 51-55 nm, about 56-60 nm, about 61-65 nm, about 66-70 nm, about 71-75 nm, about 76-80 nm, about 81-85 nm, about 86-90 nm, about 91-95 nm, or about 96-100 nm. In further exemplary embodiments, the nanoparticles of strontium titanate have a median volume particle size (Dv50) ranging from about 20 to about 60 nm, such as from about 30 to about 60 nm or from about 40 to about 60 nm, as determined by Transmission Electron Microscopy. In a preferred embodiment, the nanoparticles of strontium titanate have a Dv50 of about 45 nm, as determined by Transmission Electron Microscopy.

In some embodiments, at least a fraction of these nanoparticles of strontium titanate is uniformly functionalized on their surfaces with amino-functional alkoxysilane, as confirmed by Energy-Dispersive X-ray Spectroscopy (EDS). For instance, at least about 40%, at least about 50% or at least about 60% of the nanoparticles are uniformly functionalized on their surface with amino-functional alkoxysilane, as confirmed by Energy-Dispersive X-ray Spectroscopy.

In some embodiments, the amino-functional alkoxysilane has the general formula:

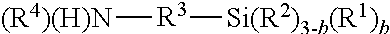

wherein: R¹ is C₁-C₆ alkyl;
R² is C₁-C₆ alkyl;
R³ is C₁-C₁₂ alkylene;
R⁴ is H or C₁-C₆ alkyl; and,
b is 1, 2 or 3.

In some embodiments: R¹ is C₁-C₂ alkyl; R² is C₁-C₂ alkyl; R³ is C₁-C₄ alkylene; R⁴ is H; and, b is 2 or 3.

Exemplary amino-functional alkoxysilanes include, but are not limited to, 3-aminopropyltrimethoxysilane, N-(2-aminoethyl)-3-aminopropyltrimethoxy silane, 3-(2-aminoethylamino)propyltriethoxysilane, N-(2-aminoethyl)-3-aminopropylmethyldimethoxysilane, 3-(2-aminoethylamino)propylmethyldimethoxysilane, 3-aminopropylmethyldiethoxysilane, 3-(2-aminoethylamino)propyldiethoxymethylsilane, 3-aminopropylmethoxydiethoxysilane, 3-(2-aminoethylamino)propyltrimethoxysilane, bis(3-trimethoxysilylpropyl)amine, bis(3-triethoxysilylpropyl)amine, N-(3-trimethoxysilylpropyl)ethylenediamine, N-(3-triethoxysilylpropyl)ethylenediamine, (3-aminopropylxmethyl)dimethoxysilane, (3-aminopropylxmethyl)diethoxysilane, N-[3-(trimethoxysilyl)propyl]butylamine, N-[3-(triethoxysilyl)propyl]butylamine, 3-(methylamino)propyltrimethoxysilane, 3-(methylamino)propyltriethoxysilane, N-[3-(trimethoxysilyl)propyl]methylamine, N-[3-(triethoxysilyl)propyl]methylamine, N-[3-(trimethoxysilyl)propyl]-N-ethylamine, N-[3-(triethoxysilyl)propyl]-N-ethylamine, N-[3-(trimethoxysilyl)propyl]-N-methylamine, N-[3-(triethoxysilyl)propyl]-N-methylamine, N-[3-(trimethoxysilyl)propyl]-N-butylamine, N-[3-(triethoxysilyl)propyl]-N-butylamine, N-(trimethoxysilylpropyl)-N-cyclohexylamine, N-(triethoxysilylpropyl)-N-cyclohexylamine, 3-(diethylamino)propyltrimethoxysilane, 3-(diethylamino)propyltriethoxysilane, 3-(diethylamino)propylmethyldimethoxysilane, 3-(diethylamino)propylmethyldiethoxysilane, N-(3-trimethoxysilylpropyl)pyrrolidine, N-(3-triethoxysilylpropyl)pyrrolidine, 3-(piperidinyl)propyltrimethoxysilane, 3-(piperidinyl)propyltriethoxysilane, and 3-(morpholinyl)propyltriethoxysilane. In some embodiments, the amino-functional alkoxysilane is selected from the group consisting of 3-aminopropyltrimethoxysilane; 3-aminopropyltriethoxysilane; 3-aminopropyldimethoxymethylsilane and, 3-aminopropyldimethoxymethylsilane. In preferred embodiment, the amino-functional alkoxysilane is 3-aminopropyltriethoxysilane.

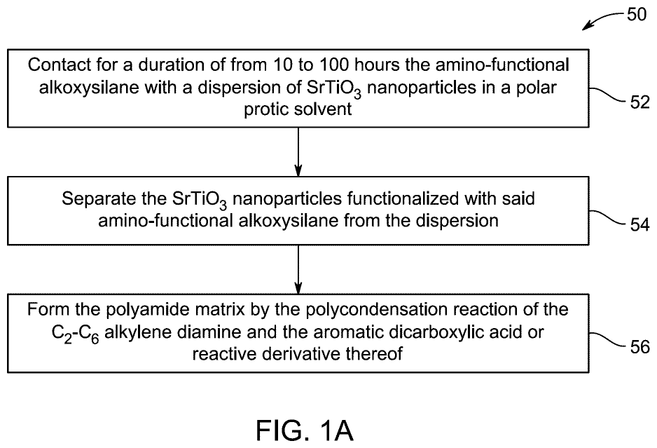

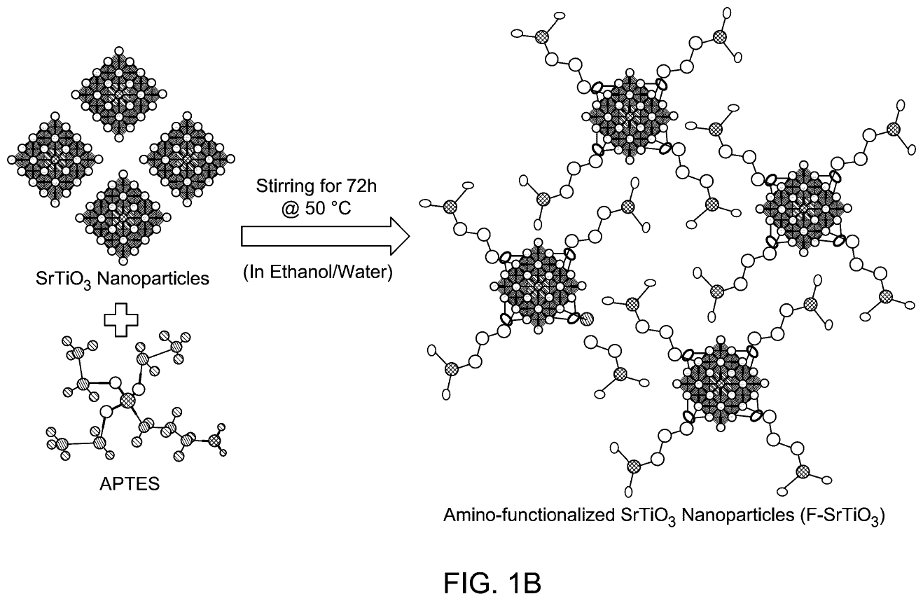

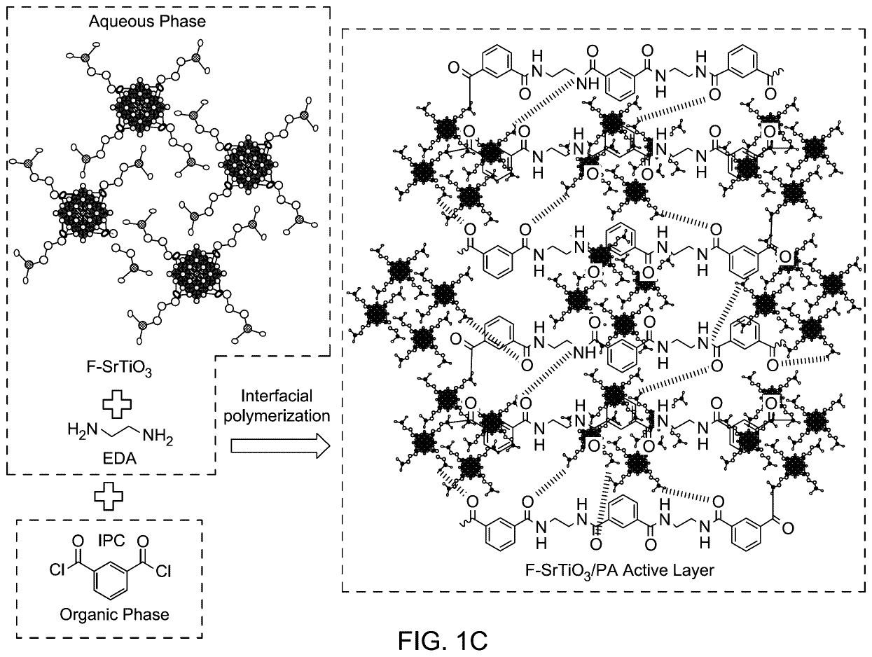

According to a second aspect of the present disclosure, a method of preparing the ultrafiltration membrane is described. FIG. 1A illustrates a schematic flow chart of a method 50 of preparing the ultrafiltration membrane. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes contacting for a duration of from 10 to 100 hours the amino-functional alkoxysilane with a dispersion of SrTiO₃ nanoparticles in a polar protic solvent. Alkoxysilanes typically hydrolyze in a polar protic solvent to form silanols, which further react with hydroxyl groups on the surface of SrTiO₃ nanoparticles, forming Si—O—Ti bond. In some embodiments, the amino-functional alkoxysilane has the general formula of (R⁴)(H)N—R³—Si(R²)_{3-b}(R¹)_{b} wherein: R¹ is C₁-C₆ alkyl; R² is C₁-C₆ alkyl; R³ is C₁-C₁₂ alkylene; R⁴ is H or C₁-C₆ alkyl; and b is 1, 2 or 3. In some embodiments, R¹ is C₁-C₂ alkyl; R² is C₁-C₂ alkyl; R³ is C₁-C₄ alkylene; R⁴ is H; and, b is 2 or 3. In preferred embodiment, the amino-functional alkoxysilane is 3-aminopropyltriethoxysilane.

The amino-functional alkoxysilane is contacted with a dispersion of SrTiO₃ nanoparticles in a polar protic solvent. Exemplary polar protic solvents include, but are not limited to, methanol, isopropanol, n-propanol, butanol, isobutanol, tert-butanol, pentanol, hexanol, cyclohexanol, ethylene glycol, propylene glycol, glycerol, formamide, dimethylformamide (DMF), acetic acid, propionic acid, lactic acid, formic acid, citric acid, phosphoric acid, trifluoroacetic acid, water, ammonia, methylamine, ethylamine, isopropylamine, n-propylamine, butylamine, sec-butylamine, tert-butylamine, diethylamine, dipropylamine, dimethylamine, triethylamine, triethanolamine, n-methylformamide (NMF), n-methylacetamide (NMA), hydrazine, hydroxylamine, and urea. In an exemplary embodiment, the polar protic solvent is a C₁-C₄ alkanol. In a preferred embodiment, the polar protic solvent is ethanol.

In some embodiments, the amino-functional alkoxysilane is contacted with a dispersion of SrTiO₃ nanoparticles for a duration ranging from about 10 to about 100 hours, including specific ranges such as about 10-15 hours, about 16-20 hours, about 21-25 hours, about 26-30 hours, about 31-35 hours, about 36-40 hours, about 41-45 hours, about 46-50 hours, about 51-55 hours, about 56-60 hours, about 61-65 hours, about 66-70 hours, about 71-75 hours, about 76-80 hours, about 81-85 hours, about 86-90 hours, about 91-95 hours, about 96-100 hours. In an embodiment, the amino-functional alkoxysilane is contacted with a dispersion of SrTiO₃ nanoparticles for a duration of from about 48 to about 96 hours or from about 60 to about 84 hours. In an exemplary embodiment, the amino-functional alkoxysilane is contacted with a dispersion of SrTiO₃ nanoparticles for 72 hours.

At step 54, the method 50 includes separating the SrTiO₃ nanoparticles functionalized with said amino-functional alkoxysilane from the dispersion. In some embodiments, the separation may be done by centrifugation, decantation, sedimentation, evaporation, filtration, or flotation. The use of filtration may be mentioned in particular, which filtration may optionally be performed under vacuum or pressure. In an embodiment, the separation is done by filtering the suspension through a filter paper. The unreacted or non-functionalized nanoparticles are removed on performing this step.

At step 58, the method 50 includes forming the polyamide matrix by the polycondensation reaction of the C₂-C₆ alkylene diamine and the aromatic dicarboxylic acid or reactive derivative thereof. Suitable examples of the C₂-C₆ alkylene diamines include, but are not limited to, propanediamine, 1,2-diaminopropane, 1,3-diaminopropane, butanediamine, 1,2-diaminobutane, 1,3-diaminobutane, 1,4-diaminobutane, pentanediamine, 1,2-diaminopentane, 1,3-diaminopentane, 1,4-diaminopentane, 1,5-diaminopentane, hexanediamine, 1,2-diaminohexane, 1,3-diaminohexane, 1,4-diaminohexane, 1,5-diaminohexane, 1,6-diaminohexane, 2-methyl-1,5-pentanediamine, and 2,2-dimethyl-1,3-propanediamine. In a preferred embodiment, the C₂-C₆ alkylene diamine is ethylenediamine.

Exemplary aromatic dicarboxylic acids which may be reacted in the polycondensation reaction—include, but are not limited to, terephthalic acid, phthalic acid, trimellitic acid, hemimellitic acid, pyromellitic acid, benzenedicarboxylic acid, naphthalene-1,4-dicarboxylic acid, naphthalene-2,6-dicarboxylic acid, anthracene-1,9-dicarboxylic acid, anthracene-2,6-dicarboxylic acid, biphenyl-4,4′-dicarboxylic acid, biphenyl-3,3′-dicarboxylic acid, diphenic acid, 4,4′-stilbenedicarboxylic acid, cinnamic acid dimer, coumarin dicarboxylic acid, quinoline dicarboxylic acid, pyridine-2,6-dicarboxylic acid, pyridine-3,5-dicarboxylic acid, quinoxaline-2,3-dicarboxylic acid, phenanthrene-9,10-dicarboxylic acid, 1,2-bis(4-carboxyphenyl)ethane, perylene-3,4-dicarboxylic acid, perylene-1,12-dicarboxylic acid, 2,5-thiophenedicarboxylic acid, 3,4-thiophenedicarboxylic acid, benzothiophene-2,3-dicarboxylic acid, benzofuran-2,3-dicarboxylic acid, and carbazole-1,3-dicarboxylic acid. The reactive derivatives of these exemplary aromatic dicarboxylic acids may also be used as the reactant. In a preferred embodiment, the aromatic dicarboxylic acid is isophthalic acid: a reactive derivate of isophthalic acid, such as isophthaloyl chloride, may also be used.

In some embodiment, the polyamide matrix is obtained by the polycondensation reaction of a C₂-C₆ alkylene diamine and an aromatic dicarboxylic acid or a reactive derivative thereof. In some embodiments, the polyamide matrix is obtained by the polycondensation reaction of a C₂-C₆ alkylene diamine with isophthalic acid, terephthalic acid or a reactive derivative thereof. In some embodiments, the polyamide matrix is obtained by the polycondensation reaction of a C₂-C₄ alkylene diamine with isophthalic acid, terephthalic acid or a reactive derivative thereof. In a preferred embodiment, the polyamide matrix is obtained by the polycondensation reaction of ethylene diamine with isophthalic acid or a reactive derivative thereof.

The polycondensation reaction may be prepared using conventional reaction conditions known to the art. It should be noted that, while reference is made to acid and amine components for purposes of determining the relative amounts of each acid and amine used to prepare the polyamide, there is no need to form a separate premix of acids and a separate premix of amines, nor is it required that all reactants be charged together at the beginning of the reaction.

Exemplary reaction conditions include but are not limited to: a temperature of from about 100° to about 300° C., such as from about 1250 to about 225° C.; an inert atmosphere; and, a duration of from about 1 to about 10 hours, such as from about 2 to about 8 hours. Those conditions aside, it is known to apply a vacuum during the final stages of the amidation reaction to facilitate removal of the final traces of water and any other volatile materials: applying a high vacuum will tend to result in the production of a polyamide having a higher molecular weight and correspondingly higher viscosity, which generally reduces the brittleness of the polyamide, as may be reflected in higher elongation values. The amidation reaction may, in certain embodiments, be performed in the presence of a catalyst, such as phosphoric acid, hypophosphoric acid, sodium benzene phosphonate or sodium benzene phosphinite.

The degree of completion of the polycondensation reaction can be determined by evaluating the acid number and the amine number of the final polymer. In general, the acid and amine components may be reacted when the final product has an acid value and an amine value less than 20 mg KOH/g, in particular less than 15 mg KOH/g.

The polycondensation reaction is performed in the presence of the functionalized SrTiO₃ nanoparticles and at an interfacial surface of the microporous support layer, including polyvinylidene fluoride. In some embodiments, the microporous support layer may include, other polymers such as, but is not limited to, polysulfone, polyethersulfone, polyacrylonitrile, polyimide, polyetherimide, polyethylene, polypropylene, polytetrafluoroethylene, nylon-6, nylon-66, cellulose acetate, cellulose nitrate, regenerated cellulose, polycarbonate, polyarylsulfone, polyphenylene oxide, polyphenylsulfone, polymethyl methacrylate, polybenzimidazole, and polyetherketone.

In some embodiments, prior to the polycondensation reaction, the method includes impregnating the microporous support layer with a fraction of the reactant C₂-C₆ alkylene diamine. This step is performed by soaking or otherwise exposing the microporous support layer including PVDF to a solution containing the C₂-C₆ alkylene diamine.

In some embodiments, the method further includes further disposing at least a fraction of the functionalized SrTiO₃ nanoparticles on the interfacial surface of the microporous support layer including PVDF. For example, at least 40%, at least 50% or at least 60% of the functionalized SrTiO₃ nanoparticles may be disposed on the interfacial surface of the microporous support layer including PVDF. The functionalized SrTiO₃ nanoparticles are disposed on the interfacial surface of the microporous support layer, likely as a thin film or evenly distributed layer. Various deposition techniques—such as spin coating, dip coating, spray coating, or electrophoretic distribution—may be used to perform this step.

According to a third aspect of the present disclosure, a method for ultrafiltration is described. The method includes flowing an oil-in-water emulsion through the ultrafiltration membrane and collecting the permeate. This permeate typically contains water that has passed through the ultrafiltration membrane, leaving the oil and other larger particles behind. The collected permeate can then be processed or filtered according to its intended purpose, while the separated oil can be recovered for reuse or proper disposal.

In some embodiments of the ultrafiltration method, the oil-in-water emulsion includes from about 10 to about 250 parts per million (ppm) by weight of oil, with specific ranges such as from about 10 to about 20 ppm, from about 20 to about 30 ppm, from about 30 to about 40 ppm, from about 40 to about 50 ppm, from about 50 to about 60 ppm, from about 60 to about 70 ppm, from about 70 to about 80 ppm, from about 80 to about 90 ppm, from about 90 to about 100 ppm, from about 100 to about 110 ppm, from about 110 to about 120 ppm, from about 120 to about 130 ppm, from about 130 to about 140 ppm, from about 140 to about 150 ppm, from about 150 to about 160 ppm, from about 160 to about 170 ppm, from about 170 to about 180 ppm, from about 180 to about 190 ppm, from about 190 to about 200 ppm, or from about 200 to about 250 ppm. In a preferred embodiment, the oil-in-water emulsion comprises about 200 ppm by weight of oil.

In some embodiments, a transmembrane pressure differential ranges from about 50 to about 200 kPa, of which exemplary ranges are about 50-60 kPa, about 60-70 kPa, about 70-80 kPa, about 80-90 kPa, about 90-100 kPa, about 100-110 kPa, about 110-120 kPa, about 120-130 kPa, about 130-140 kPa, about 140-150 kPa, about 150-160 kPa, about 160-170 kPa, about 170-180 kPa, about 180-190 kPa, about 190-200 kPa, about 50-100 kPa, about 60-120 kPa, about 70-140 kPa, about 80-160 kPa, and about 90-200 kPa. In a preferred embodiment, the transmembrane pressure differential is from about 100 to about 300 kPa.

In some embodiments, the ultrafiltration membrane has a water contact angle in air (Θ_{w,a}) ranging from about 65° to about 75°, including specific ranges such as about 65-66°, about 66-67°, about 67-68°, about 68-69°, about 69-70°, about 70-71°, about 71-72°, about 72-73°, about 73-74°, about 74-75°. In some embodiments, the ultrafiltration membrane has a water contact angle in air (Θ_{w,a}) ranging from about 65-70°, for example about 66-71°, about 67-72°, about 68-73°, about 69-74°, about 70-75°, about 65-71°, about 66-72° about 67-73° or about 68-74°. In a preferred embodiment, the ultrafiltration membrane has a water contact angle in air (Θ_{w,a}) of 68.1°.

In some embodiments, the ultrafiltration membrane has an oil contact angle in air (Θo,a) ranging from about 0° to about 10°, such as about 0-1°, about 1-2°, about 2-3°, about 3-4°, about 4-5°, about 5-6°, about 6-7°, about 7-8°, about 8-9° or about 9-10°. In further embodiments, the ultrafiltration membrane has an oil contact angle in air (Θo,a) of about 0-2°, about 1-3°, about 2-4°, about 3-5°, about 4-6°, about 5-7°, about 6-8°, about 7-9°, about 8-10°. In a still further embodiment, the ultrafiltration membrane has an oil contact angle in air (Θo,a) ranging from about 0° to about 5°. In a preferred embodiment, the ultrafiltration membrane has an oil contact angle in air (Θo,a) of 0°.

In some embodiments, the ultrafiltration membrane has an oil contact angle in water (Θo,w) ranging from about 155° to about 165°, including specific ranges such as about 155-156°, about 156-157°, about 157-158°, about 158-159°, about 159-160°, about 160-161°, about 161-162°, about 162-163°, about 163-164° or about 164-165°. In further embodiments, the ultrafiltration membrane has an oil contact angle in water (Θo,w) of about 155-160°, about 156-161°, about 157-162°, about 158-163°, about 159-164°, about 160-165°, about 155-161°, about 156-162°, about 157-163° or about 158-164°. In a preferred embodiment, the ultrafiltration membrane has an oil contact angle in water (Θo,w) of 159.9°.

The ultrafiltration membrane of the present disclosure may be used in either direct flow filtration—wherein the aqueous dispersion feed stream is forced through the membrane at a substantially perpendicular angle—or tangential flow filtration (TFF), where the aqueous dispersion feed stream flows along and tangentially to the surface of the ultrafiltration membrane.

Direct flow filtration may be preferred where the feed stream is characterized by a low concentration of particulates—such as in the ultrafiltration of an aqueous dispersion feed stream comprising or consisting of oil and water—given that there would be reduced residue build up on the surface of the membrane during filtration. Whilst direct flow filtration may be performed continuously, it is preferably performed in a batch or semi-continuous manner, permitting the membrane to be cleaned between use cycles to remove residue build-up.

As noted, however, membrane separation by tangential flow filtration is not precluded in the present disclosure. Conventionally, the retentate stream in tangential flow filtration is recycled. It is also typical for tangential flow filtration to be performed as a continuous process because a constant flow of the feed stream across the surface of the ultrafiltration membrane may prevent the accumulation of residues on the surface thereof.

Where ultrafiltration of the aqueous dispersion is conducted by tangential flow filtration, the feed of the aqueous dispersion may be represented as a laminar flow and thereby characterized by a shear rate. The shear rate of the aqueous dispersion may typically be from about 1000 to about 10000 s⁻¹, for example from about 2000 to about 10000 s⁻¹, from about 2000 to about 8000 s⁻¹ or from about 4000 to about 8000 s⁻¹.

Independently of the use of direct flow or tangential flow filtration, the method of ultrafiltration of the present disclosure may be performed at a transmembrane pressure differential, specifically a pressure difference between the retentate and permeate side of the membrane. Whilst the tolerance limit of the membrane may be a determinative of the operable transmembrane pressure differential, it is conventional herein to apply a transmembrane pressure differential of from about 50 to about 500 kPa. Exemplary transmembrane pressure differentials of from about 50 to about 400 kPa, about 50 to about 300 kPa or about 100 to about 300 kPa may be mentioned.

The transmembrane pressure differential may be controlled by inter alia: pressurizing the aqueous dispersion feed with a gas; adjusting the column height of the aqueous dispersion above the ultrafiltration membrane; through the use of pumps to adjust the flow rate of the fluids on the retentate side of the ultrafiltration membrane; through controlling drainage on the permeate side of the ultrafiltration membrane; and/or, through the use of suction applied to the permeate side of the ultrafiltration membrane.

The transmembrane pressure differential may be maintained at a constant value within the aforementioned ranges during the ultrafiltration process. In the alternative, the transmembrane pressure differential may be moderated to provide a constant permeate flow rate: typically in this circumstance, the transmembrane pressure differential will increase during an ultrafiltration process or cycle and should, of course, be monitored to ensure that the pressure tolerance limit of the membrane is not exceeded.

In present disclosure, the ultrafiltration membrane having a flux of at least 50 Lm⁻² h⁻¹ as determined at about 100 kPa and about 25° C. in accordance with ASTM D5090-20. In some embodiments, the ultrafiltration membrane exhibits a flux ranging from about 50 to about 400 Lm⁻²h⁻¹, including exemplary ranges such as about 50-60 Lm⁻²h⁻¹, about 60-70 Lm⁻²h⁻¹, about 70-80 Lm⁻²h⁻¹, about 80-90 Lm⁻²h⁻¹, about 90-100 Lm⁻²h⁻¹, about 100-110 Lm⁻²h⁻¹, about 110-120 Lm⁻²h⁻¹, about 120-130 Lm⁻²h⁻¹, about 130-140 Lm⁻²h⁻¹, about 140-150 Lm⁻²h⁻¹, about 150-160 Lm⁻²h⁻¹, about 160-170 Lm⁻²h⁻¹, about 170-180 Lm⁻²h⁻¹, about 180-190 Lm⁻²h⁻¹, about 190-200 Lm⁻²h⁻¹. In certain exemplary embodiments, the ultrafiltration membrane has a flux of about 200-250 Lm⁻²h⁻¹, about 250-300 Lm⁻²h⁻¹, about 300-350 Lm⁻²h⁻¹ or about 350-400 Lm⁻²h⁻¹, as determined at approximately 200 kPa and 25° C. in accordance with ASTM D5090-20. In a preferred embodiment, the ultrafiltration membrane has a flux of 310 Lm⁻²h⁻¹ at approximately 200 kPa and 25° C.

### EXAMPLES

The following examples demonstrate an ultrafiltration membrane, a method of preparing the ultrafiltration membrane and a performance of the aforementioned membrane in oil-in-water emulsion separation. The examples are provided solely for illustration and are not to be construed as limitations of the present disclosure, as many variations thereof are possible without departing from the spirit and scope of the present disclosure.

### Example 1: Materials

Strontium titanate (SrTiO₃), 3-aminopropyltriethoxysilane (APTES), ethylenediamine (EDA), isophthaloyl chloride (IPC), polyvinylidene fluoride (PVDF), polyvinylpyrrolidone (PVP), dimethylformamide (DMF) were procured from Sigma-Aldrich (USA). Solvents such as n-Hexane, ethanol and methanol were purchased from local supplier.

### Example 2: Synthesis of Functionalized Strontium Titanate (F—SrTiO₃)

In order to functionalize the SrTiO₃ particles, 0.1 gram (g) of the SrTiO₃ was dispersed in an ethanol-water mixture (95 vol. % ethanol; 5 vol. % water), where 5 mL of APTES was added to the solution and the solution was continuously stirred for 72 hours at 50° C. The obtained product was isolated by filtering the suspension through a filter paper (Branchia qualitative filter paper) and washed with ethanol and excess water to remove any of the unreacted reactants from the reaction mixture. The thus obtained F—SrTiO₃ was dried in an air-forced oven (Sci FineTech) at 80° C. for 2 hours. The exemplified reaction scheme for the synthesis of F—SrTiO₃ is shown in the FIG. 1B.

### Example 3: Fabrication of F—SrTiO₃/PA@PVDF Membrane

The ultrafiltration membrane was fabricated on a PVDF support, wherein the PVDF support was prepared by a non-solvent induced phase inversion technique as shown in FIG. 1B. The PVDF dope solution was prepared by dissolving 15 g of PVDF and 5.0 g of PVP in 80 g NMP. Further, a dope solution was cast on a tempered glass surface using a doctor's blade with a slit size of 150 μm and followed by immediate immersion in distilled water bath leading to coagulation of PVDF.

The F—SrTiO₃ nanoparticles were stabilized in the active layer through an IP reaction on the PVDF support. Furthermore, for fabricating membranes, 0.1 g of F—SrTiO₃ nanoparticles were dispersed in an aqueous ethylenediamine (EDA) solution and reacted with an n-hexane solution comprising 0.15% w/v of isophthaloyl chloride (IPC). In addition, the PVDF support was fixed in a dead-end filtration cell (Sterlitech HP4750). The solution of F—SrTiO₃ nanoparticles in EDA was passed through the PVDF support under N₂ pressure. The aforementioned process resulted in the deposition of the F—SrTiO₃ nanoparticles and the impregnation of EDA in the PVDF support. The membrane was removed from the cell and dried in air. Following drying, the membrane was soaked for 60 seconds in a solution including IPC to complete the interfacial polymerization reaction. Following the interfacial polymerization reaction between F—SrTiO₃ nanoparticles, EDA, and IPC, the obtained membrane was washed with fresh n-hexane to remove any of the unreacted IPC from the membrane. Hence, the obtained membrane was kept in the air-forced oven for 1 hour at 80° C. to enhance the degree of crosslinking of the generated polyamide active (PA) layer containing F-SrTIO₃ and the membrane was named F—SrTiO₃/PA@PVDF membrane. Different phases and steps involved in the fabrication of the F—SrTiO₃/PA@PVDF membrane are provided in FIG. 1C.

### Example 4: Characterization of the SrTiO₃ and SrTiO₃/PA@PVDF Membrane

A plurality of characterization techniques were used to evaluate the F—SrTiO₃ and the SrTiO₃/PA@PVDF membrane. Functional groups were determined by the Fourier transform infrared (FTIR) spectroscopy (Nicolet) where the completely dried samples of the F—SrTiO₃ and SrTiO₃/PA@PVDF membrane were exposed to a laser source and recoding the spectra from wavenumber range of 400 cm⁻¹ and 4000 cm⁻¹ and 32 scans were run for each sample. The crystallographic data of the F—SrTiO₃ and SrTiO₃/PA@PVDF membrane was collected by wide-angle powder X-ray diffraction (PXRD) (Rigaku, Japan). The dried samples were placed on a stage and exposed to an X-ray beam and the spectra were recorded from a range of 5° to 80°. Furthermore, the surface morphologies of the F—SrTiO₃ and SrTiO₃/PA@PVDF membrane were revealed by scanning electron microscopy (SEM) of the samples where the samples were coated with a gold layer before executing the SEM analysis. Different areas of the samples were scanned and micrographs were recorded for studying the surface features of the membranes. EDX and mapping analysis of the samples were carried out by an online elemental analyzer (OXFORD) equipped with the SEM instrument. The surface wettability of the membranes was measured by the sessile drop method using a goniometer where 2 microliters (μL) of water droplet was dropped on a membrane surface and the measurements were made by an online microscopy equipped with the instrument.

### Example 5: Oil/Water Separation Performance Studies of F—SrTiO₃/PA@PVDF Membrane

The O/W separation performance of the membrane was studied by installing the membranes in a dead-end filtration cell (Sterlitech HP4750). Initially, the membrane was compacted using distilled water as feed at a pressure of 1 bar (0.1 MPa) until a steady permeance was achieved. Following compaction, the distilled water feed was replaced by an O/W emulsion prepared by dissolving diesel oil in water at a concentration of 1 g/L equivalent to 1000 ppm which was later diluted to a desired concentration when required during the experiments. 100 mg of SDS was also added as an emulsifier followed by rigorous stirring at around 30000 revolutions per minute (rpm) using a shear mixer (AIKUZ High Shear Emulsifier, China). The emulsion was found significantly stable over an elongated duration. Different examinations such as the effect of increasing transmembrane pressure and oil concentration were carried out in terms of variation in the permeate flux and O/W separation efficiency of the membrane. The permeate flux of the membrane was evaluated using equation 1.

$$J = \frac{V}{A \times t} \qquad ( 1 )$$

In equation 1, ‘J’ (L m⁻² h⁻¹) represents the permeate flux of the pure water, ‘A’ (m²) is the given effective membrane and ‘t’ is the time (h) for collecting a given volume V (L) of the permeate.

The separation efficiency of the membrane was determined by equation 2.

$$Seperation efficiency ( \% ) = \frac{( {c}_{f} - {c}_{i} )}{{c}_{i}} \times 100 \qquad ( 2 )$$

Where ‘C_{f}’ and ‘Cᵢ’ represent the final and initial concentrations of oil in O/W emulsions. The concentration of the oil in the emulsion was measured by a turbidity meter.

### Example 6: Photocatalytic Self-Cleaning Studies of the Membrane

In order to regenerate the fouled F—SrTiO₃/PA@PVDF membrane, photocatalytic self-cleaning evaluations were conducted. Further, to photo-catalytically remove the organic foulant (oil) from the fouled membrane surface, the fouled F—SrTiO₃/PA@PVDF membrane was exposed to the appropriate light source for 60 minutes. The performance of the membrane in terms of permeate flux and separation efficiency was assessed thereafter.

### Results

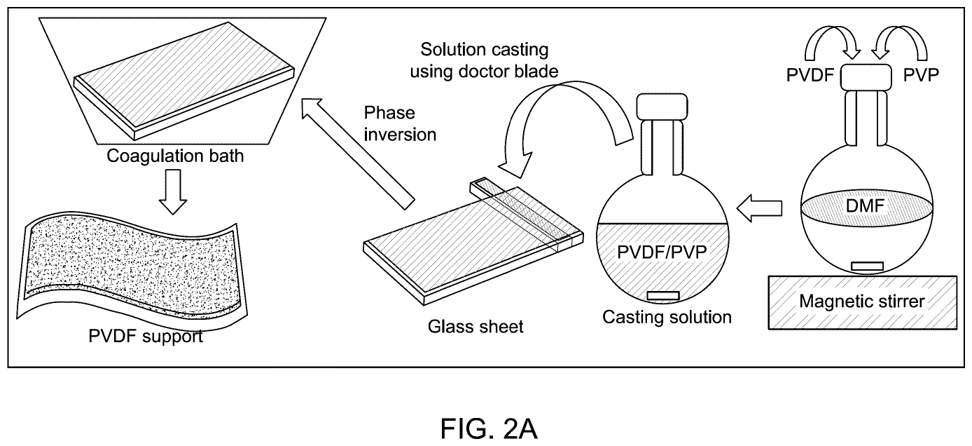

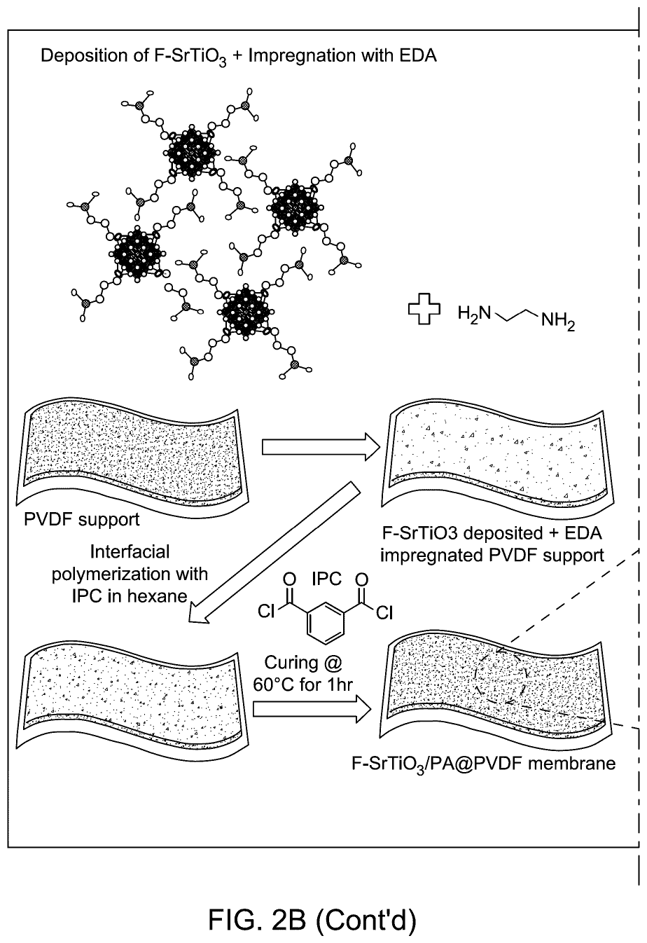

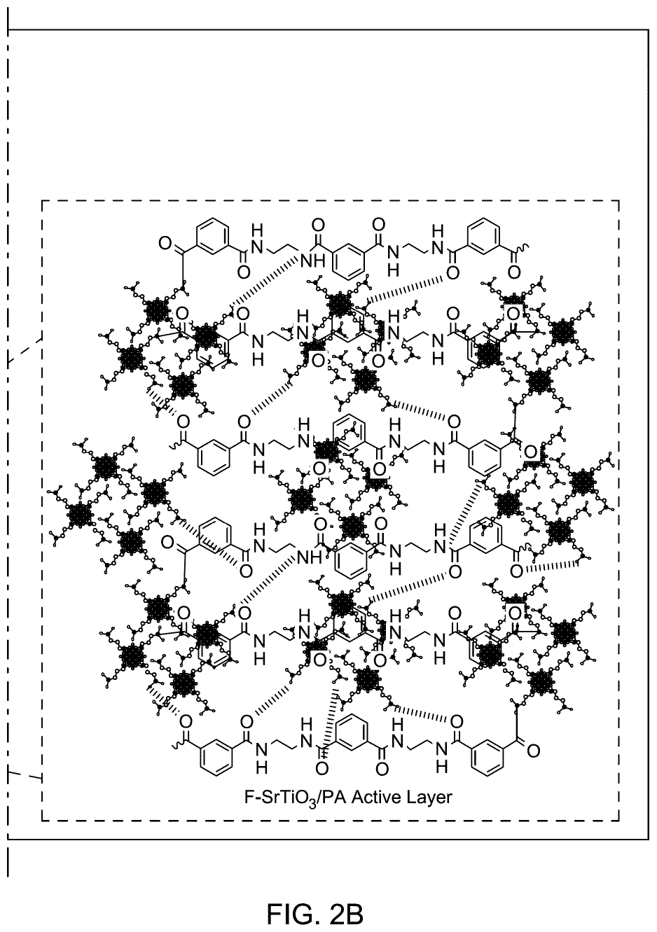

The ultrafiltration membrane as described in the present disclosure is configured such that the SrTiO₃ nanoparticles take part in the interfacial polymerization reaction on the surface of porous PVDF membrane support, hence, the SrTiO₃ nanoparticles were decorated with amino groups, using 3-aminopropyltriethoxysilane yielding F—SrTiO₃, as shown in FIG. 2A. Post-functionalization, the F—SrTiO₃ had the desirable chemistry to take part in the interfacial polymerization reaction with the isophthaloyl chloride (IPC) yielding a stable active layer having SrTiO₃ as an integral part of the structure of the membrane, as shown in FIG. 2B. In addition, the presence of one or more amide bonds in the linear polyamide chains originating from the reaction between IPC and EDA may provide a potential for extensive hydrogen bonding between the F—SrTiO₃ membrane and EDA/IPC polyamide. The aforementioned bonding may result in stability of the active layer. Moreover, it is considered that the above-described amino-functionalized chemistry may lead to development of strong hydrogen bonding with the water molecules under filtration conditions, rendering the F—SrTiO₃/PA@PVDF membrane super-oleophobic underwater.

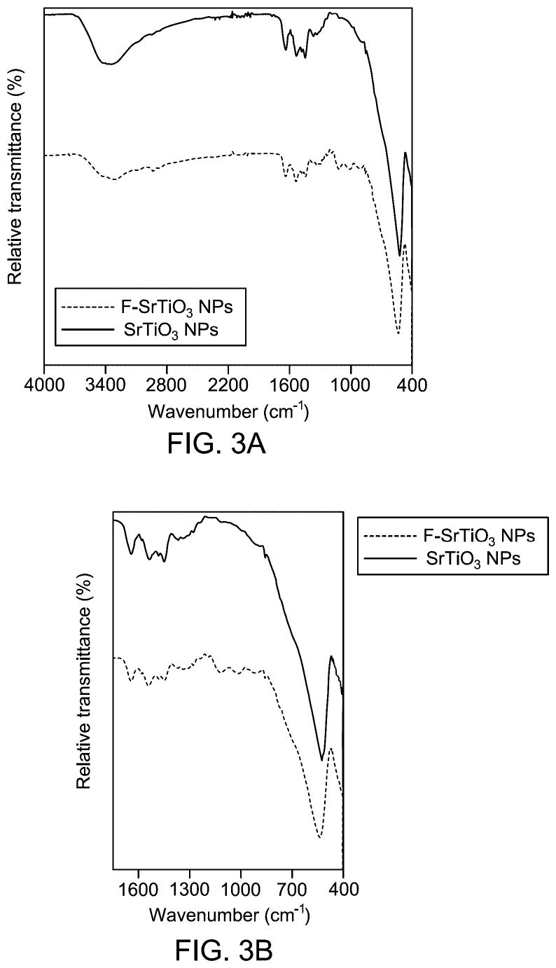

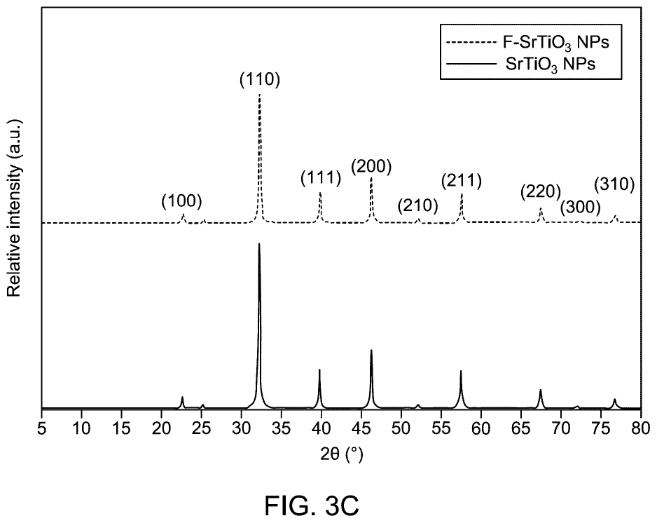

The existence of the one or more surface functional groups was confirmed by FTIR analysis of the pristine SrTiO₃ and F—SrTiO₃ nanoparticles. The FTIR peaks of SrTiO₃ located at around 3400 cm⁻¹ and 1640 cm⁻¹ were due to the O—H stretching vibrations owing to the presence of certain —OH groups on the surface of the SrTiO₃ due to absorption of some moisture from the air given that SrTiO₃ has high potential for absorbing water. Further, the peaks at 1450 cm⁻¹ and 1380 cm⁻¹ were due to the C—H bending vibrations, which indicate that a certain quantity of the precursors used for the synthesis of SrTiO₃ was present in the SrTiO₃ nanoparticles [See: Wu, Z., et al., Ag@SrTiO₃ nanocomposite for super photocatalytic degradation of organic dye and catalytic reduction of 4-nitrophenol, New Journal of Chemistry 41, 5678-5687 (2017), the disclosure of which is incorporated herein by reference in its entirety]. However, the characteristic strong absorption band is located in the region spanning from 850 cm⁻¹ to 500 cm⁻¹ which is an area attributed to metal-oxygen (M-O) bonds such as Sr—O and Ti—O bonds, found in the structure of the SrTiO₃ nanoparticles. In case of F—SrTiO₃, all the peaks of the SrTiO₃ were identified with additional peaks located at 2900 cm⁻¹ and 2850 cm⁻¹ which are due to the sp³ —C—H stretching vibration of the alkyl chains of 3-aminopropyltriethoxysilane (APTES), as shown in FIGS. 3A-3B. Further, to examine crystallographic features of the F—SrTiO₃, Powder X-Ray Diffraction (PXRD) was conducted, as shown in FIG. 3C, where all of the characteristic peaks were identified as reported previously [See: Le, M. V. et al., Manipulating the structure and characterization of Sr1-xLaxTiO₃ nano-cubes toward the photodegradation of 2-naphthol under artificial solar light, Catalysts 2021, Vol. 11, Page 564 11, 564 (2021), the disclosure of which is incorporated herein by reference in its entirety]. The pattern of the peaks remained same for the F—SrTiO₃ nanoparticles, wherein the peaks for the SrTiO₃ were well identified but the intensity of the peaks due to SrTiO₃ was significantly reduced. The aforementioned observation may be attributed to the slight masking of the planes of the SrTiO₃ nanoparticles but does, on the other hand, confirm the functionalization of the SrTiO₃ nanoparticles by APTES.

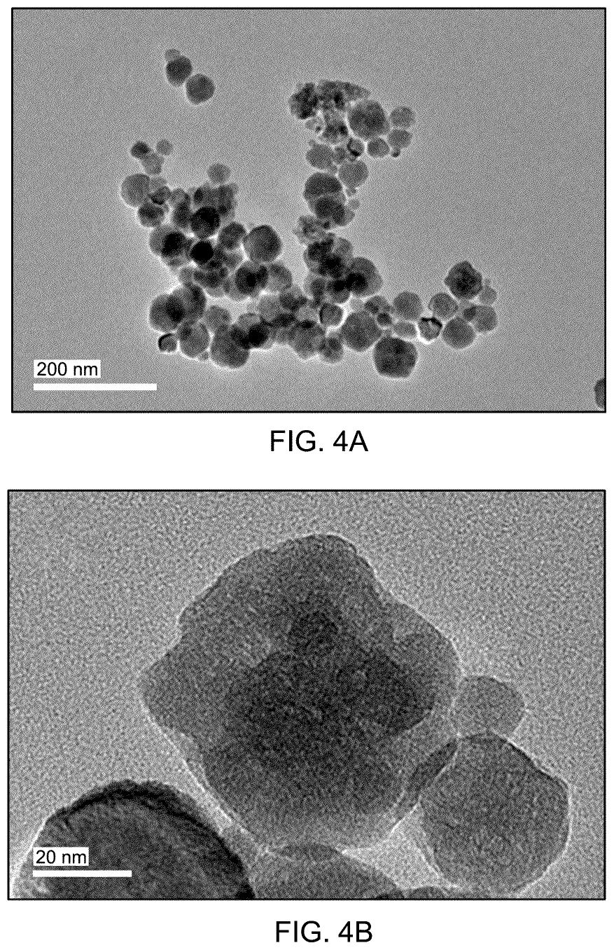

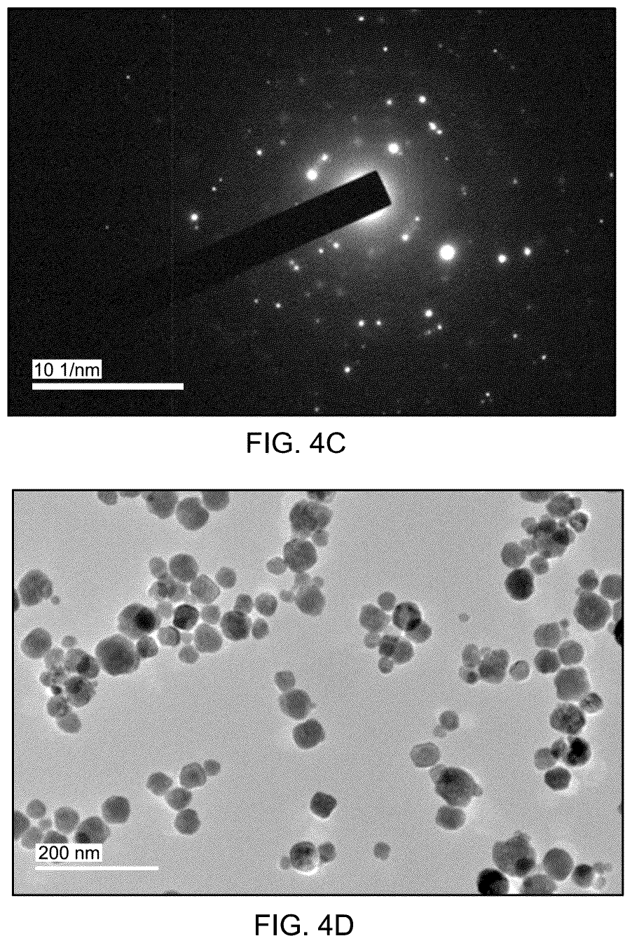

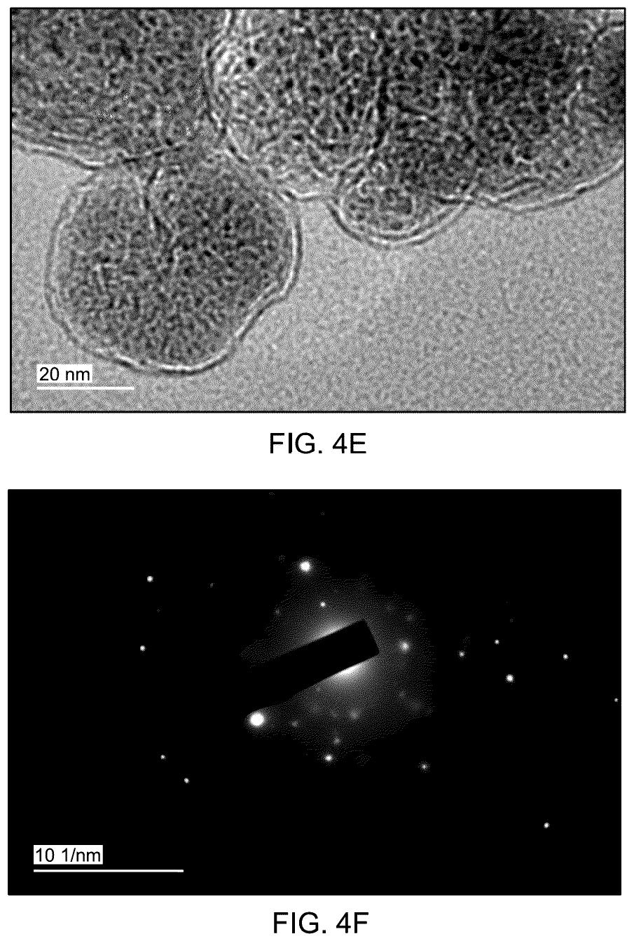

The functionalization and internal structure of the SrTiO₃ and F—SrTiO₃ were confirmed by the field emission transmission electron microscopy (FETEM) analysis. The SrTiO₃ nanoparticles appeared to have a square to irregular granular shape, with an median volume particle size of about 45 nanometers (nm), as shown in FIGS. 4A-4B. The rings with bright spots observed in the selected area electron diffraction (SAED) pattern confirmed the polycrystalline structure of the SrTiO₃, as shown in FIG. 4C, which corroborates the diffractogram recoded during PXRD measurements. Furthermore, the overall shape of the F-SrTiO₃ nanoparticles resembled the SrTiO₃, as shown in FIG. 4D, but the structure of the F—SrTiO₃ nanoparticles appeared to be slightly altered with specific wavy patterns: a brain-like morphology of the F—SrTiO₃ nanoparticles is observed in FIG. 4E. Moreover, the SAED pattern appeared to have a reduction in the quantity of the bright spots, as shown in FIG. 4F, which confirmed that APTES functionalization has resulted in covering the original planes of SrTiO₃ nanoparticles: this above described effect was observed for PXRD of F—SrTiO₃.

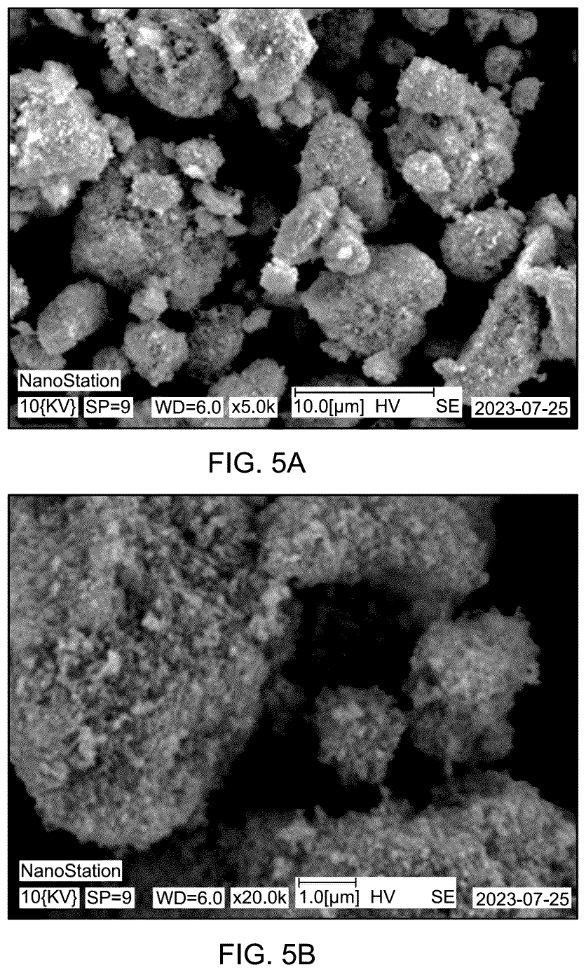

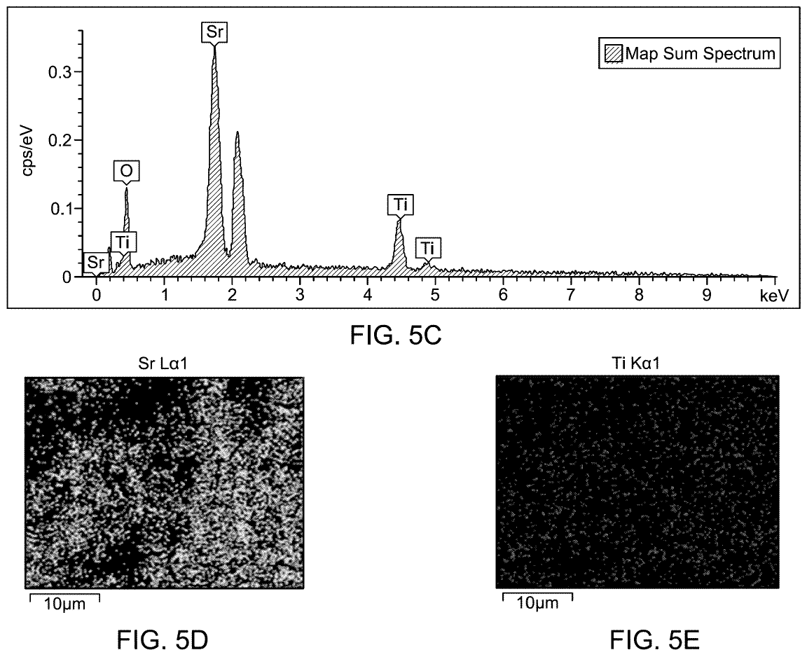

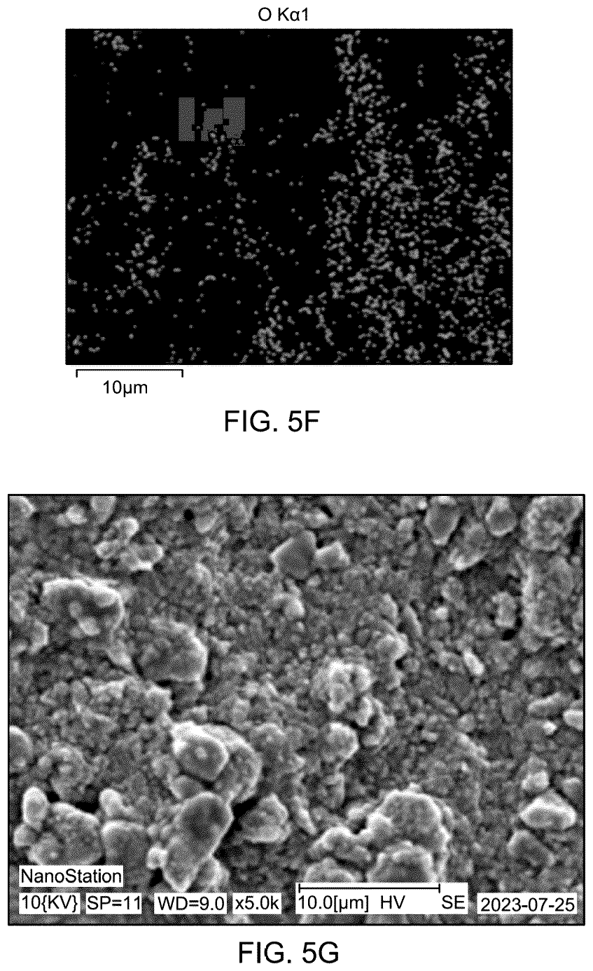

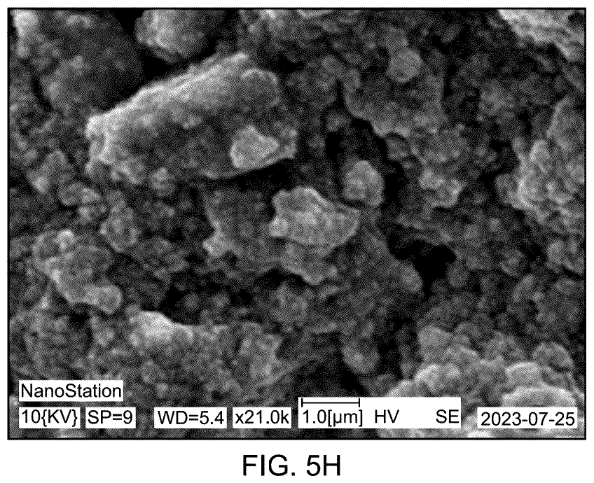

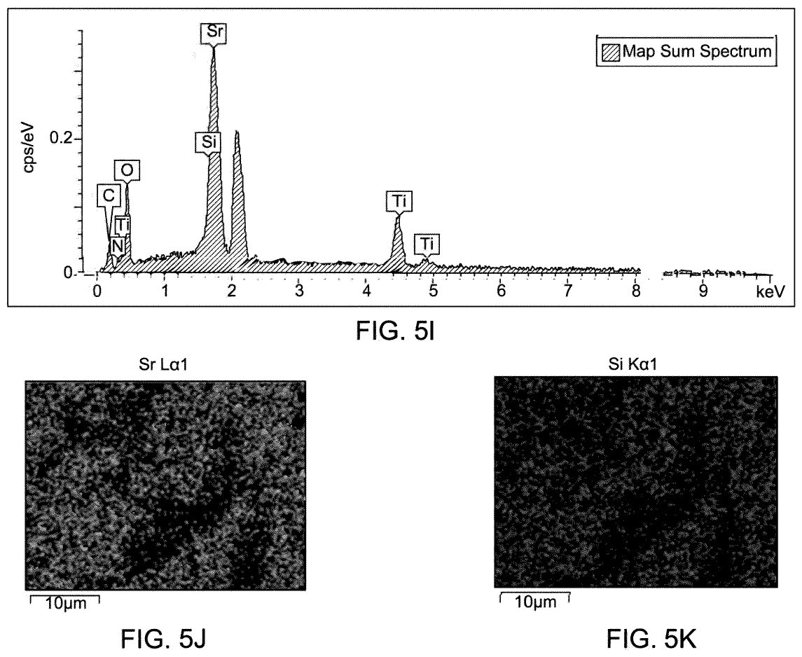

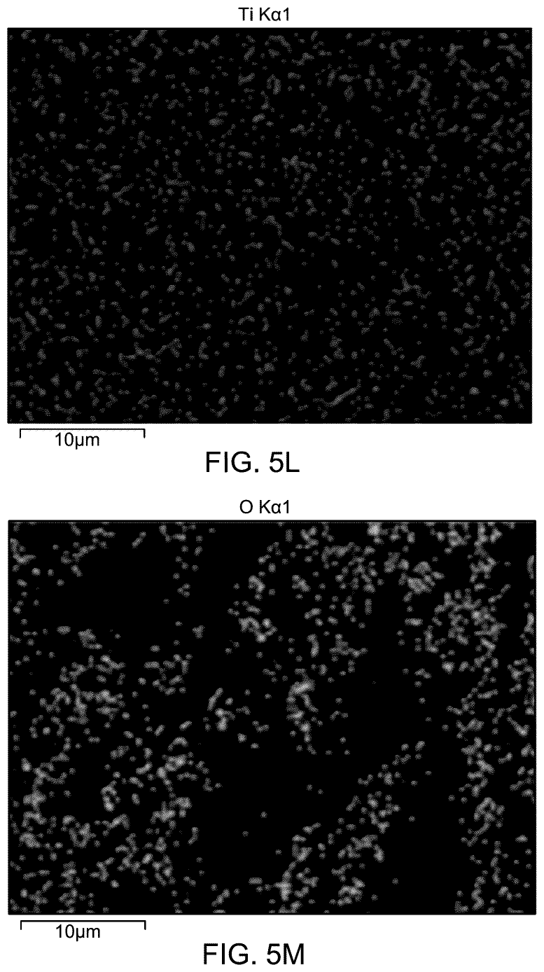

Following the analysis of the one or more functional groups and physical features of the SrTiO₃ and F—SrTiO₃, the surface morphologies and chemical composition were investigated by surface SEM analysis and EDX analysis, the results of which are shown in FIGS. 5A-5O. The surface of the SrTiO₃ nanoparticles appeared to be highly fluffy and rough with a cotton-like appearance, as shown in FIGS. 5A-5B. The anticipated elemental composition—including Sr, Ti, and O—is confirmed in FIG. 5C. The mapping analysis identified the same elements spread over the entire area of the sample which further confirmed that there was a high concentration of Sr, as shown in FIG. 5D, followed by Ti, as shown in FIG. 5E: 0, as shown in FIG. 5F, was the least abundant in the elemental composition analysis of the sample examined.

The surface SEM analysis of the F—SrTiO₃ revealed a marked variation in the morphology of nanoparticles where the nanoparticles became smoother and more agglomerated compared to the SrTiO₃ as shown in FIGS. 5G-5H: this might be attributed to the functionalization of SrTiO₃ by APTES which results in varying the surface chemistry of the nanoparticles. All the elements detected in SrTiO₃ were also found to be present in F—SrTiO₃. However, some additional elements—such as silicon (Si), carbon (C), and nitrogen (N)—were also found in the case of F—SrTiO₃, as shown in FIG. 5I. The presence of these elements may be attributed to the existence of APTES in the F—SrTiO₃. Moreover, the elements were found to be uniformly distributed over the entire structure of the F—SrTiO₃, as indicated by the mapping analysis shown in FIGS. 5J-5O.

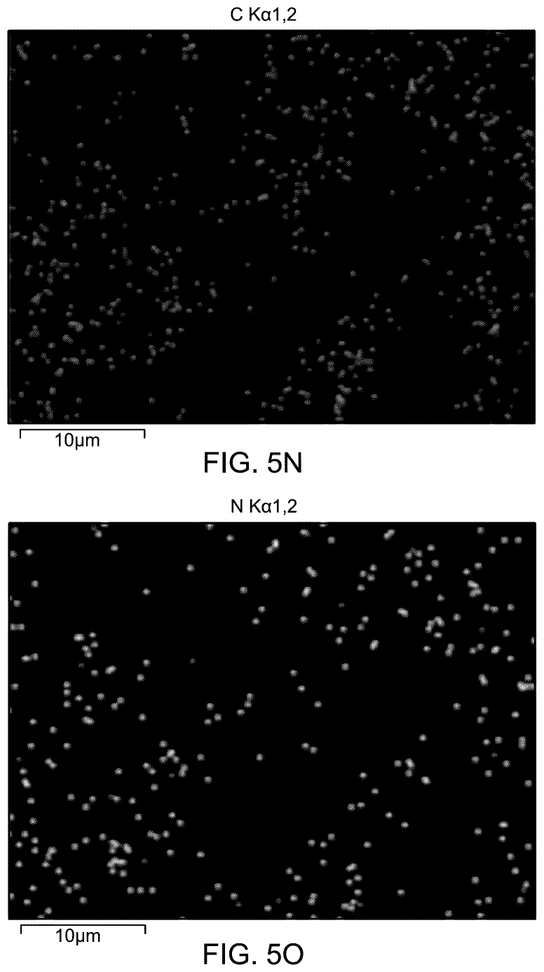

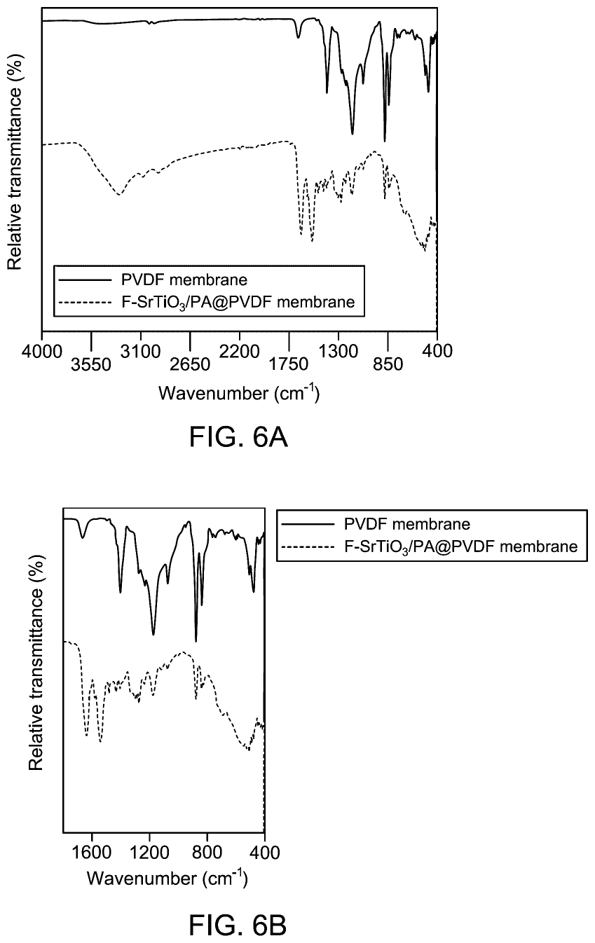

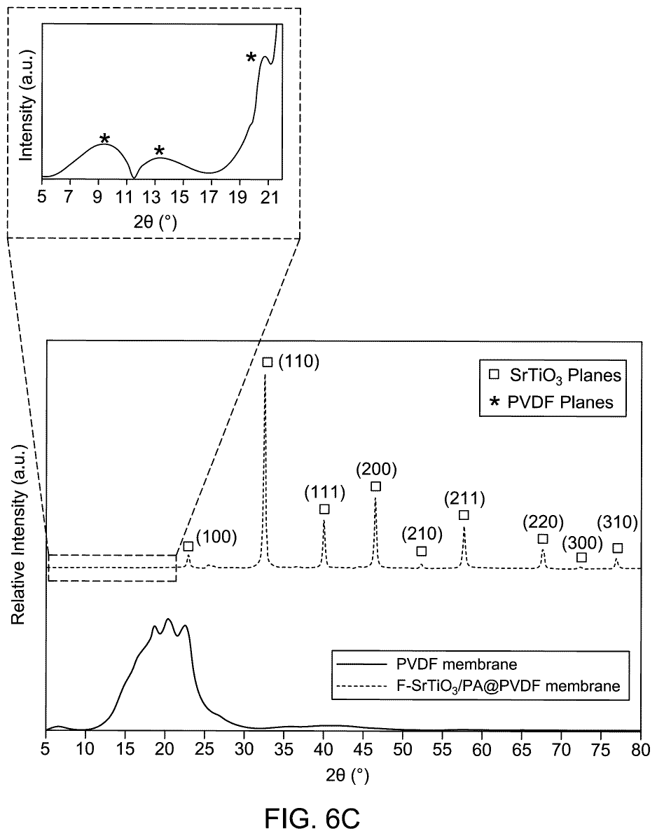

Following the thorough characterization of the SrTiO₃ and confirming the proper functionalization of the F—SrTiO₃ nanoparticles, the structural and physical features of the membranes were examined. The functional groups found in the membranes were identified by the FTIR analysis, as shown in FIGS. 6A-6B. In the case of pristine PVDF membrane, the peaks located at 2900 cm⁻¹ are due to CH₂ stretching whereas the peaks at 1180 cm⁻¹ are due to CF₂ vibrations [See: Wu, T. at al., Facile and low-cost approach towards a PVDF ultrafiltration membrane with enhanced hydrophilicity and antifouling performance via graphene oxide/water-bath coagulation, RSC Adv 5, 7880-7889 (2015), the disclosure of which is incorporated herein by reference in its entirety]. For the F—SrTiO₃/PA@PVDF membrane, several new peaks were identified by the FTIR analysis, where it may be seen that a broad and deep absorption band is visible in the region of 3550 cm⁻¹ to 3300 cm⁻¹ owing to the presence of several amide bonds generated during interfacial polymerization between EDA and IPC. The other peaks located at 3050 cm⁻¹, 2900 cm⁻¹, and 2850 cm⁻¹ are due to sp² C—H and sp³ C—H stretching vibrations of the benzene rings of IPC and CH₂ groups of the EDA. The carbonyl (>C═O) peaks appeared in the region of 1640 cm⁻¹ further confirming the formation of a polyamide network (amide I vibration). Another peak located at 1550 cm⁻¹ was attributed to the amide II vibration of the polyamide [See: Alhazmi, H. A. et al., Spectroscopic characterization of the interactions of bovine serum albumin with medicinally important metal ions: platinum (IV), iridium (III) and iron (II), Acta Biochim Pol 68, 99-107 (2021), the disclosure of which is incorporated herein by reference in its entirety]. Yet another characteristic peak confirming the impregnation of SrTiO₃ was found in the 850 cm⁻¹ to 500 cm⁻¹ range. The XRD analysis of the F—SrTiO₃/PA@PVDF membrane was carried out to confirm the growth of SrTiO₃ containing polyamide active layer following interfacial polymerization, as shown in FIG. 6C. The PVDF diffractogram peaks of the support matched the peaks reported in the literature [See: Abdullah, I. Y., et al. Facile Formation of β poly (vinylidene fluoride)films using the short time annealing process, Advances in Environmental Biology, Vol. 9 http://www.aensiweb.com/AEB/(2015), the disclosure of which is incorporated herein by reference in its entirety].

The XRD diffractogram of the F—SrTiO₃/PA@PVDF membrane confirmed the formation of a composite active layer containing all the constituents including polyamide due to the interfacial polymerization reaction between EDA and TMC as well as F—SrTiO₃ and TMC. The broad peaks are shown in the low-angle range of 9° while the others appear to be merged with the PVDF peaks at 140 and 20°. The remaining peaks were attributable to the PXRD pattern of the SrTiO₃.

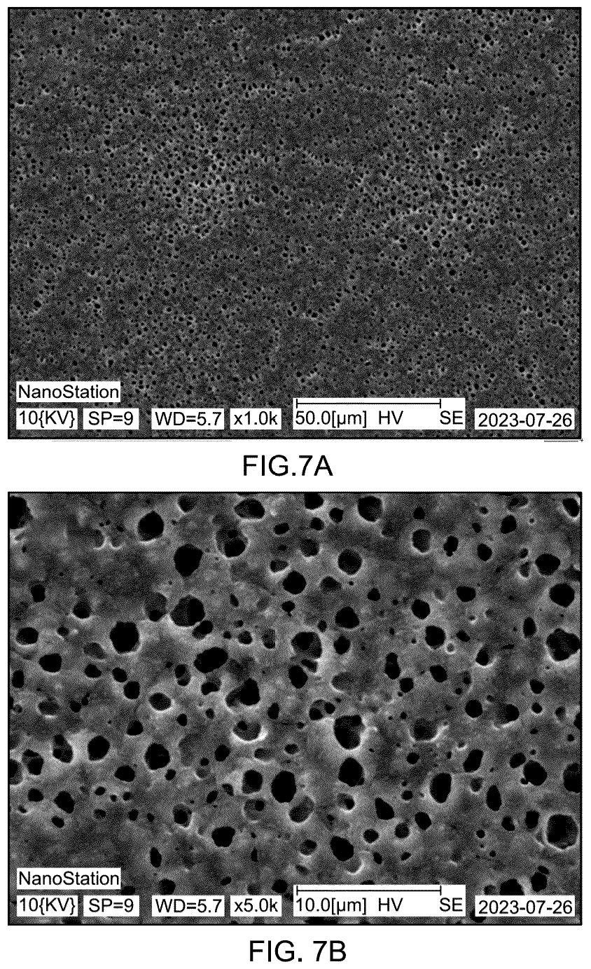

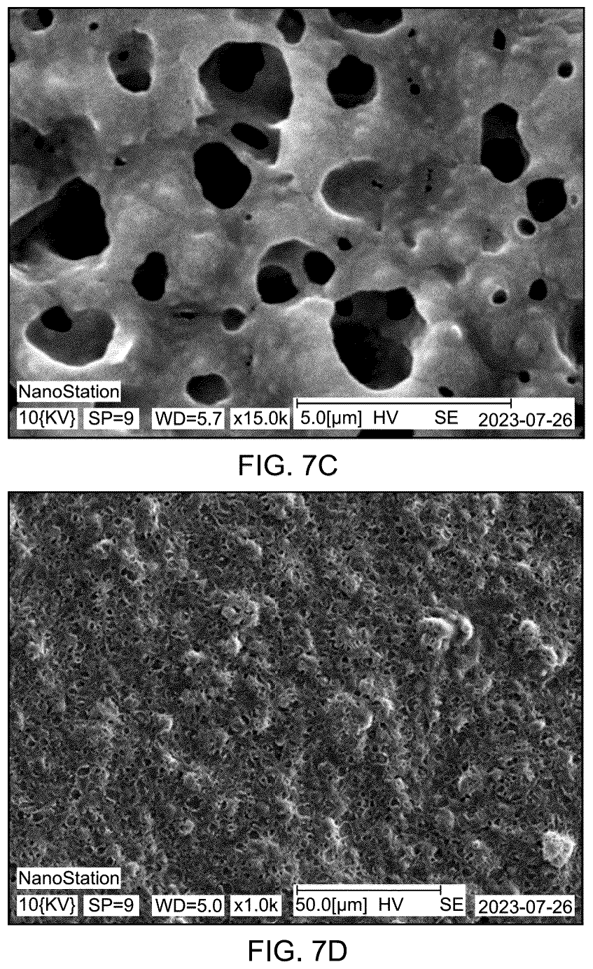

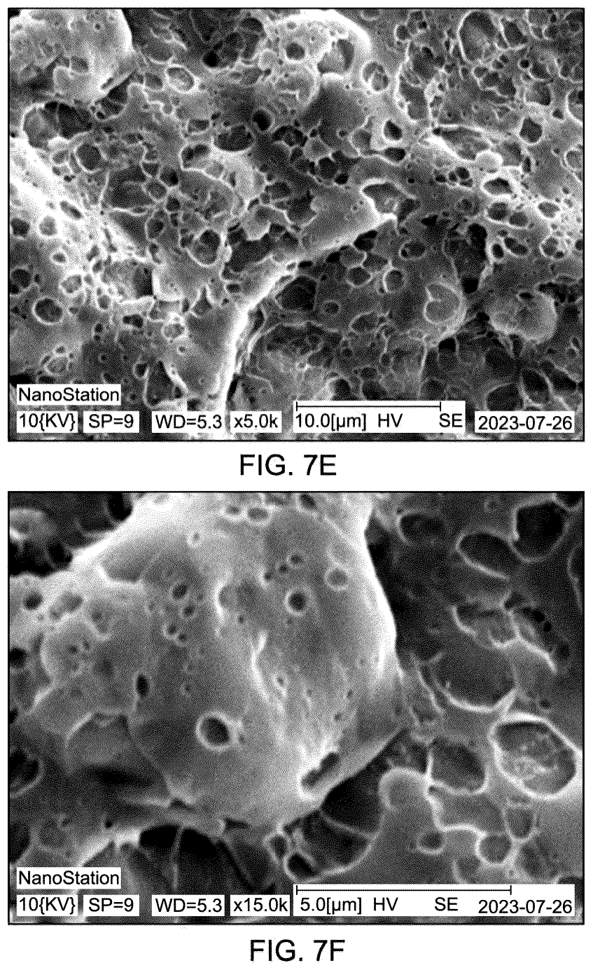

The surface morphology of the samples was examined in order to determine the performance of the membranes during filtration conditions. The bare PVDF support appeared porous owing to the phase inversion process which was evident when moved to higher magnifications. The surface SEM analysis of the PVDF membrane revealed a uniform distribution of the micropores across all the membrane area, as shown in FIGS. 7A-7C. However, in the case of the F—SrTiO₃/PA@PVDF membrane, these pores were completely covered owing to the growth of the composite polyamide generated during interfacial polymerization, as shown in FIGS. 7D-7F. The surface of the F—SrTiO₃/PA@PVDF membrane depicted an embedded bead morphology in the network of the polyamide. The beads represent the F—SrTiO₃ nanoparticles deposited in the active layer, whereas the polyamide network shows several pits. A continuous active layer composed of F—SrTiO₃ and polyamide is a desirable feature for the separation processes during filtration experiments.

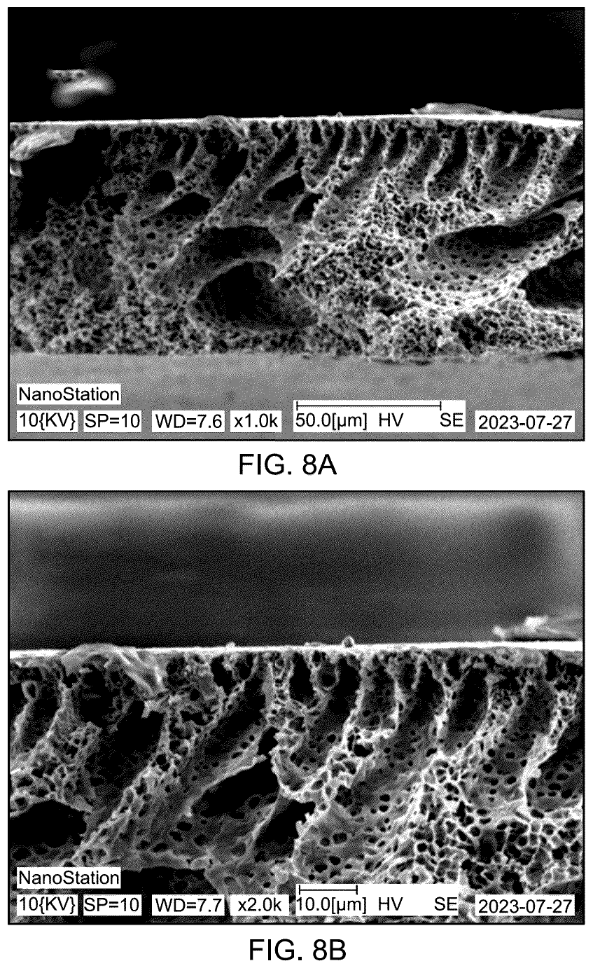

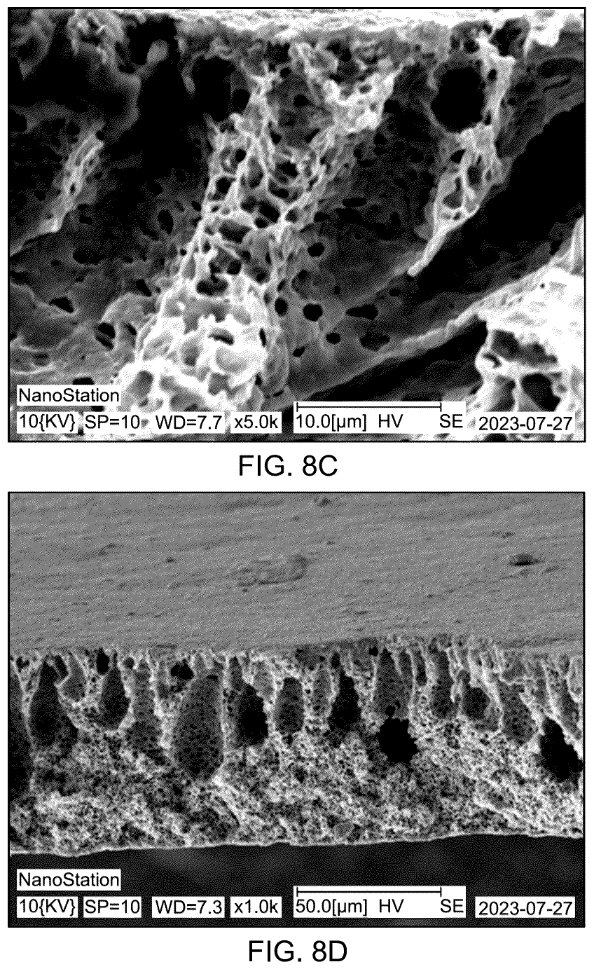

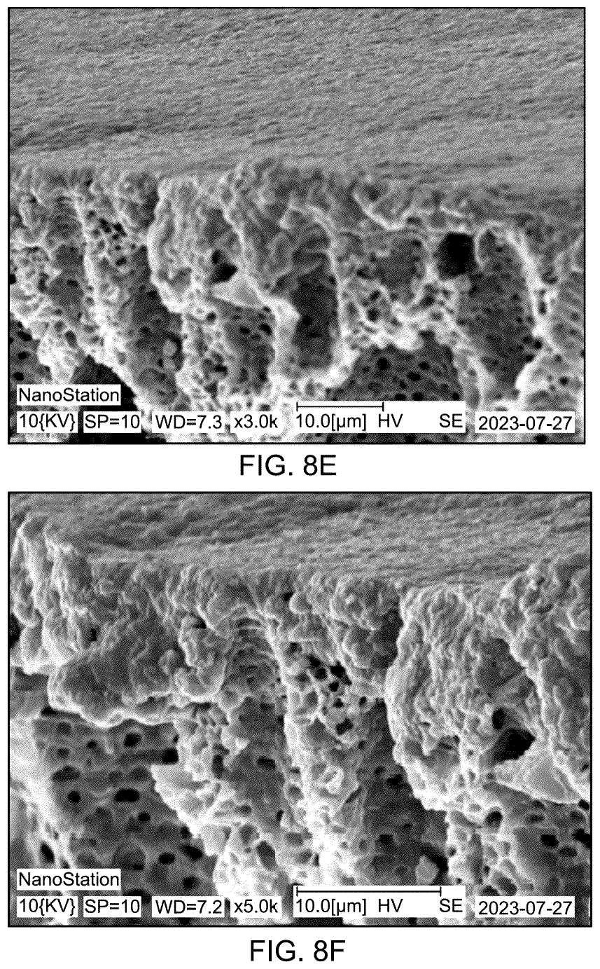

The fabricated membrane has a composite structure constituted by a top active layer of F—SrTiO₃/PA and a bottom layer of PVDF support. FIGS. 8A-8C show the structure of the PVDF support, wherein the finger-like projections are visible owing to the phase inversion process with a spongy nature. The spongy nature of the PVDF finger-like projections may be attributed to the slow phase inversion process of the PVDF in the aqueous phase. The aforementioned architecture may be desirable for oil-in-water emulsion (O/W) separation during filtration tests. It is required that the PVDF support only serves as a support and offers no resistance to mass transfer during filtration conditions. The separation process is carried out by the active layer which is evident in the case of F—SrTiO₃/PA@PVDF membrane. FIGS. 8D-8F show the composite nature of the F—SrTiO₃/PA@PVDF membrane, wherein the top active layer was distinctly visible and originated due to the interfacial polymerization process between the EDA, F—SrTiO₃, and IPC. The polyamide polymer is decorated with SrTiO₃ nanoparticles, as can be seen in the higher magnification micrographs of the F—SrTiO₃/PA@PVDF membrane provided in FIG. 8F. The top active layer was dense and continuous, unlike the PVDF support which included finger-like bigger channels and numerous pores required for permeation of pure water separated from the oil.

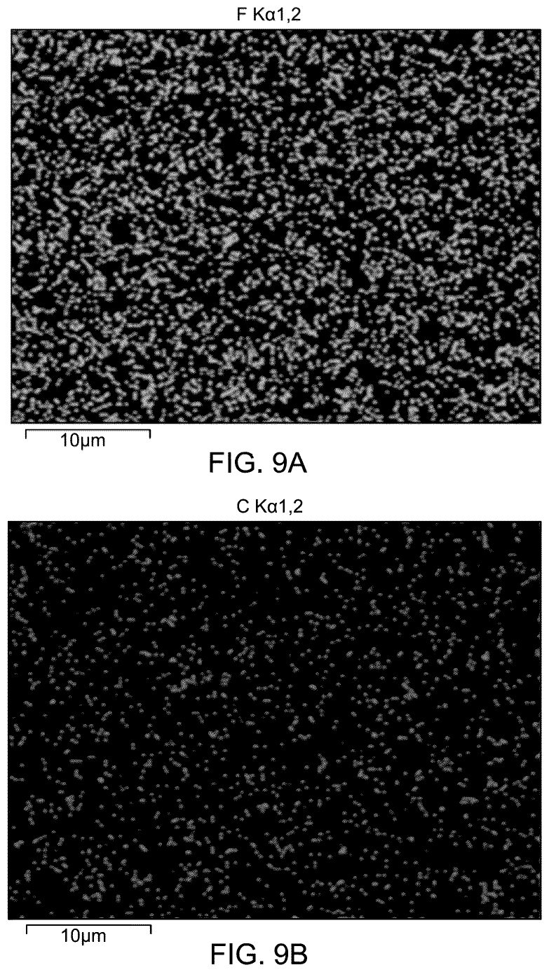

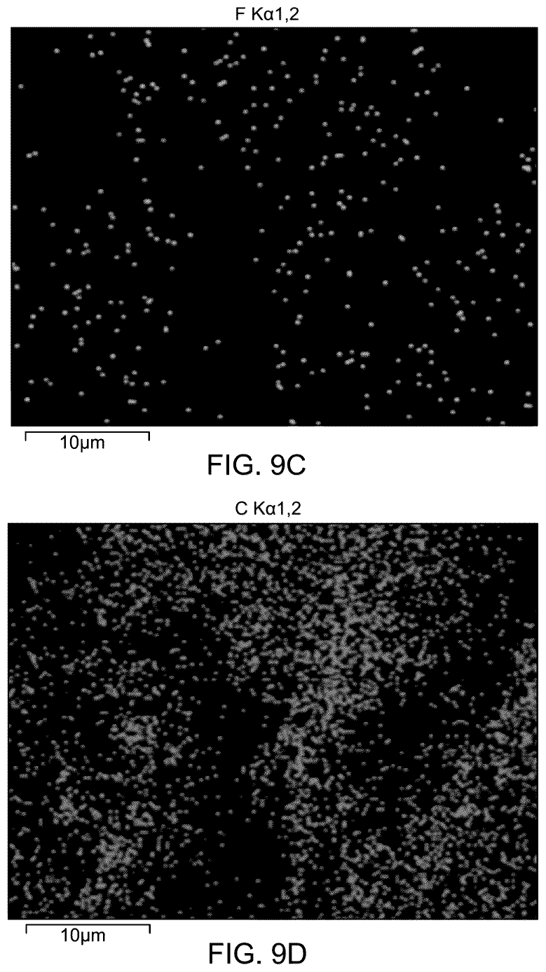

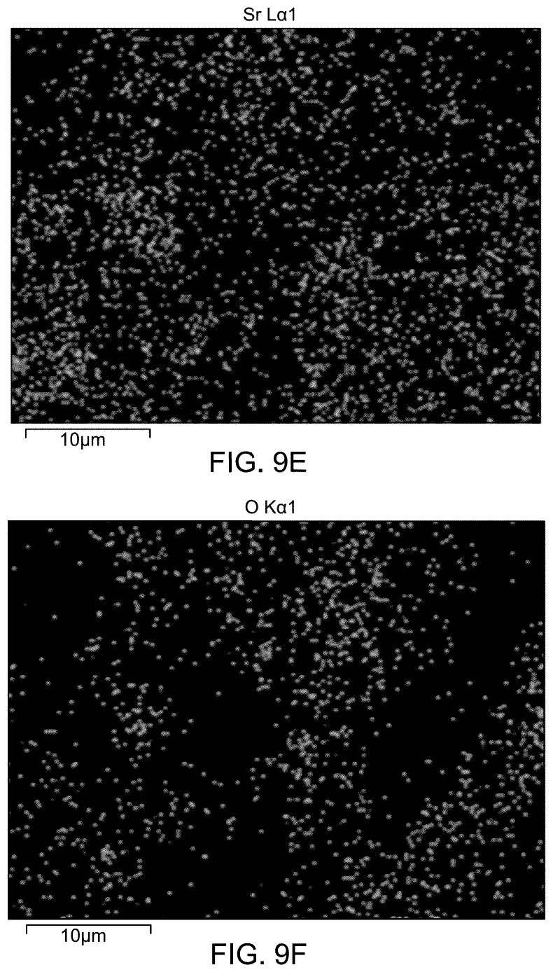

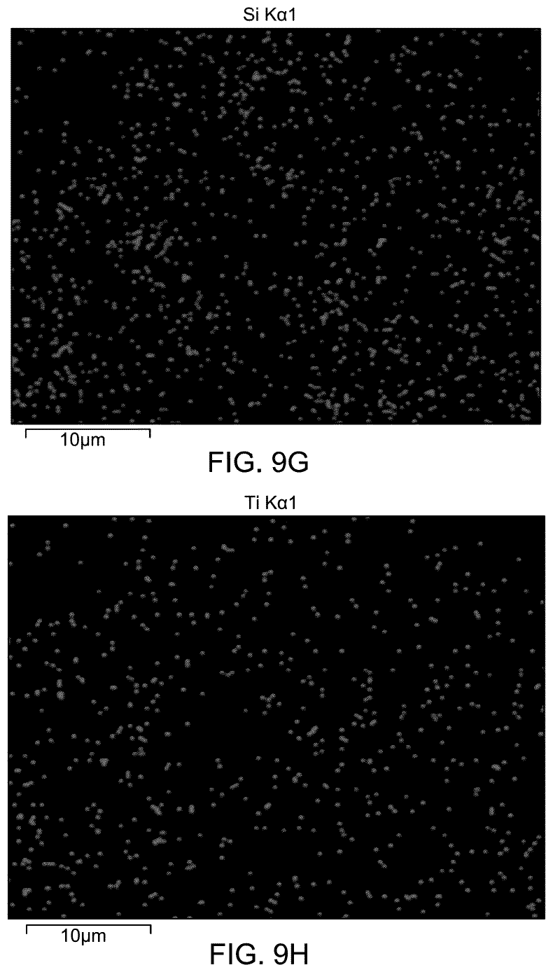

Further, chemical composition examination was conducted to evaluate the structure of the membranes. The mapping analysis of the membranes is provided in FIGS. 9A-9I. In the case of PVDF support as shown in FIGS. 9A-9C, the mapping analysis revealed uniformly distributed fluorine (F) and carbon (C) owing to the chemical structure (—CH₂—CF₂—) of the PVDF support: F and C were the integral components of the support. However, for the mapping analysis of the F-SrTiO₃/PA@PVDF membrane, several elements were detected in the structure of the F—SrTiO₃/PA@PVDF membrane, as shown in FIGS. 9D-9I. A lower concentration of F compared to pristine PVDF was detected, which confirmed the excessive masking of the PVDF support by the active layer after interfacial polymerization. Since the active layer is not thick enough to block the penetration of the X-ray beam during analysis, it still measured a certain quantity of F in the elemental composition of the F—SrTiO₃/PA@PVDF membrane. The presence of other elements such as C, Sr, O, Si, Ti, and N is confirmatory evidence for the successful interfacial polymerization reaction leading to the growth of a polyamide active layer containing F—SrTiO₃ nanoparticles embedded in the EDA/IPC framework. The mapping analysis further specified the variation in the densities of the mapping dots among different elements. The densities of F and C are the highest among all the elements because these are the most abundant of all the elements found in the structure of the membranes. In the case of the F—SrTiO₃/PA@PVDF membrane, after F and C, Sr was the most abundant followed by Si, Ti, and O which had nearly similar concentrations. N is the least abundant among all the other elements. The aforementioned observations agree with the composition of the membrane fabricated in the present disclosure following the interfacial polymerization reaction between EDA, F—SrTiO₃, and IPC.

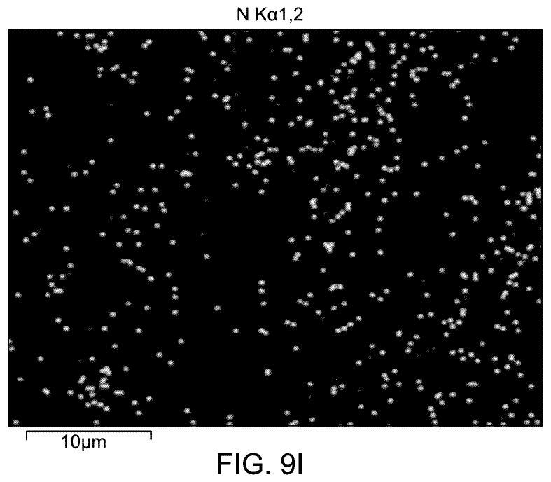

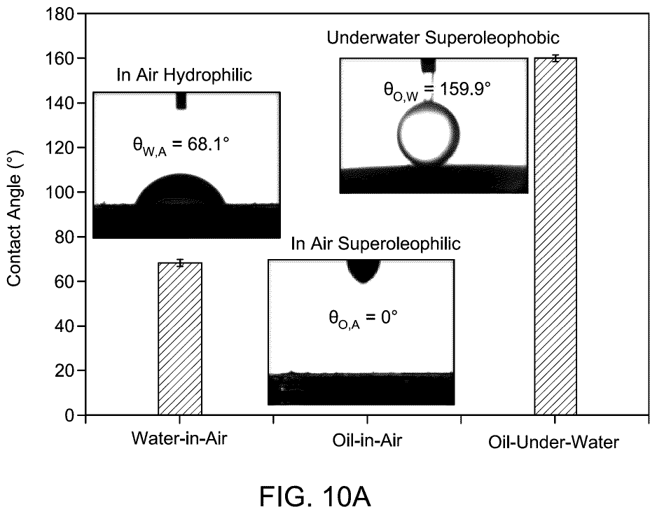

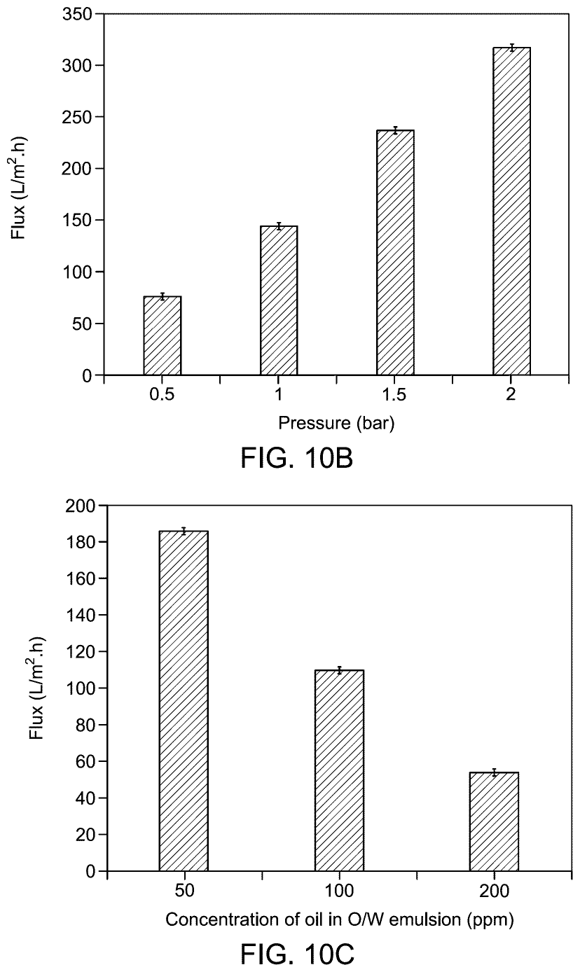

Furthermore, surface wettability is a vital parameter for determining the behavior of the membranes during filtration conditions. In general, a highly hydrophilic membrane surface is required to avoid membrane fouling during oil-in-water (O/W) emulsion separation. The membrane surface wettability was measured by using the water contact angle (WCA) (θ_{w}) in the air (θ_{W,A}) and oil contact angle (OCA), (θ_{O}) in the air (θ_{O, A}) and underwater (θ_{O,W}) as shown in FIGS. 10A-10D. The membranes showed a hydrophilic nature with a θ_{W, A} of about 68.1° while having a super oleophilic nature in the air with θ_{O, A} of about 0°. A highly desirable feature for efficient O/W separation was observed when the oil contact angle was measured underwater. Underwater, the membrane showed a super oleophobic surface feature with θ_{O, W} of about 159.9°, as shown in FIG. 10A. The underwater super-oleophobic nature of the prepared membranes may result in separating the oil from water since the oil is not able to wet the membrane surface whereas water is readily allowed to pass through the membrane. The super-oleophobic characteristic may be attributed to the chemistry of the membrane surface which is composed of several hydrophilic functions, such as amide linkages (—CONH), SrTiO₃, hydrolyzed —COOH groups of IPC and unreacted amines (—NH₂).

Further, the performance analysis of the membranes, as illustrated in FIGS. 10B-10D, depicted the effect of increasing the transmembrane pressure. The transmembrane pressure effect was evaluated using an emulsified feed containing crude oil in distilled water at a concentration of about 100 ppm. When different transmembrane pressures were applied, the permeate flux was found to be increased with increasing transmembrane pressure. The highest pressure that was established during the experimentation was about 2 bar (0.2 MPa) where a permeate flux of 310 L m⁻² h⁻¹ was measured, as shown in FIG. 10B. Furthermore, the separation efficiency of the F—SrTiO₃/PA@PVDF membrane was found to be significantly higher as it was estimated to be greater than 99%, as shown in FIG. 10C. The high separation efficiency of the F—SrTiO₃/PA@PVDF membrane may be attributed to a uniformly grown active layer composed of EDA, F—SrTiO₃ and IPC with a special surface wettability of being super oleophobic underwater.

In addition, the effect of increasing oil concentration (ppm) in the water was evaluated, where different concentrations of oil were examined, which included 50 ppm, 100 ppm, and 200 ppm oil-in-water (O/W) emulsions, respectively. The permeate flux decreased with an increase in the feed concentration of the oil. The permeate flux was recorded to be 185 L m⁻² h⁻¹, 110 L m⁻² h⁻¹, and 56 L m⁻² h⁻¹ for 50 ppm, 100 ppm, and 200 ppm feed concentrations, respectively, at a pressure of 1 bar (0.1 MPa), as shown in FIG. 10D. The decrease in permeate flux may be attributed to the effect of concentration polarization (CP) whereby an increase in the concentration of the solutes (oil components/droplets) on the feed side of the membrane results in increasing the concentration gradient from the feed side of the membrane to the permeate side. Therefore, a higher feed pressure/transmembrane pressure has to be applied to overcome the new higher concentration gradient. Hence, at the same feed pressure, the permeate flux undergoes reduction and reaches lower values. The O/W separation efficiency remained nearly constant at about >99% for all the tested feed concentrations. Therefore, the membrane showed stable separation efficiency for different feed concentrations including the highest oil concentration (200 ppm) used in the present disclosure.

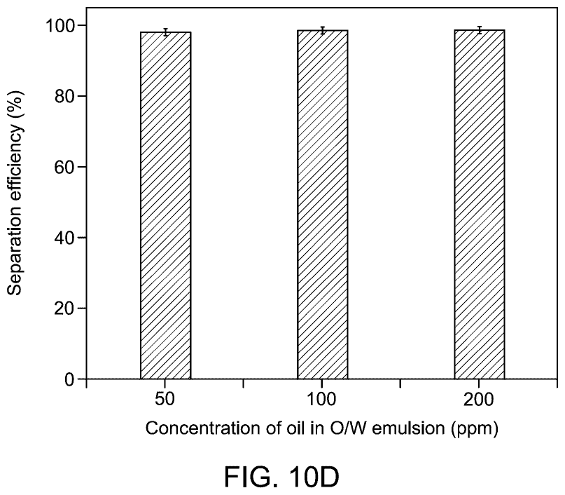

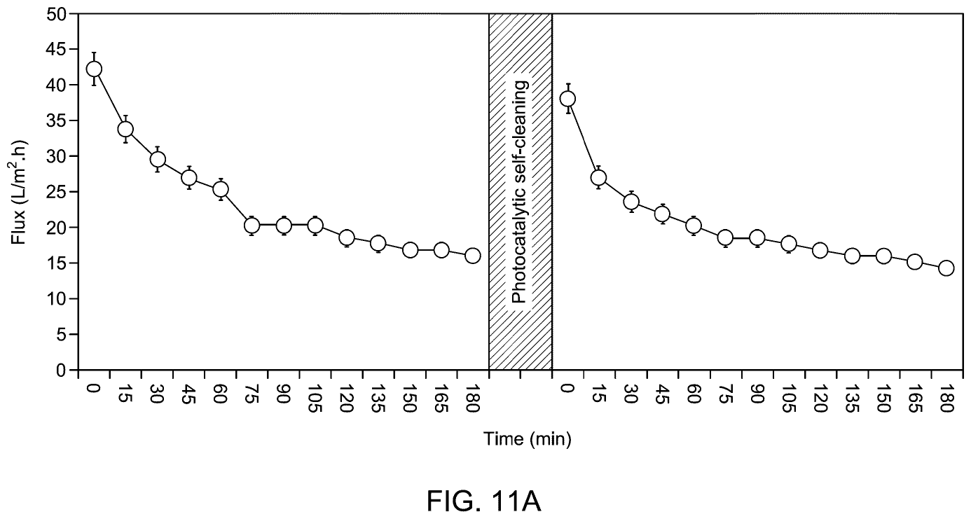

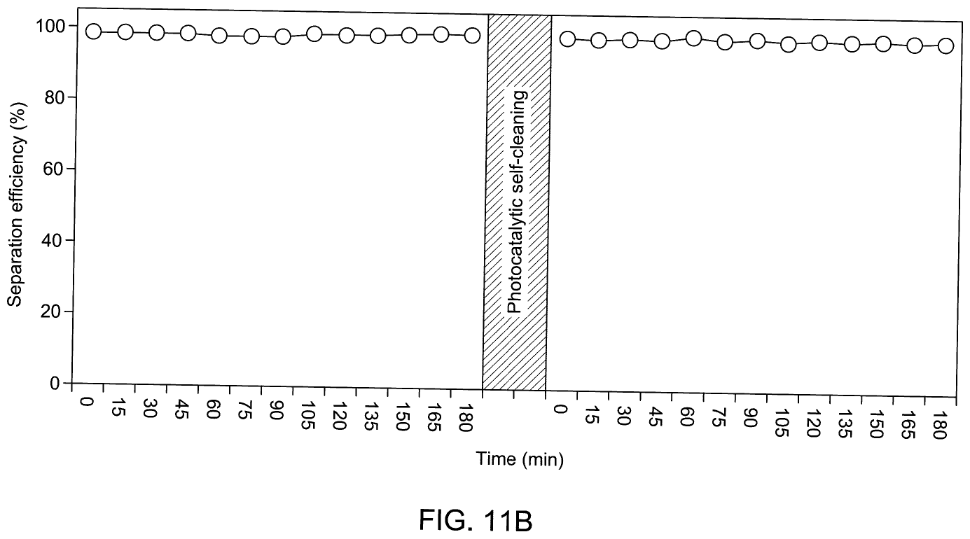

Since membrane fouling is inevitable under all possible circumstances when the feed has some solutes or contaminants. Even though the membrane surface is underwater super-oleophobic, the membrane showed a reduction in permeate flux during stability tests where a feed of 200 ppm crude oil-in-water was used. The permeate flux showed a sharp decline in the initial testing duration, specifically in the initial 60 minutes where it decreased from 42 L m⁻² h⁻¹ to 25 L m⁻² h⁻¹. The decline in permeate flux is purported to result from the attachment of the dissolved oil droplets to the membrane surface during filtration conditions. During the initial testing stage, numerous active sites were available for binding the foulants to the membrane surface, which sites are eventually covered resulting in the decline in the permeate flux owing to the establishment of a fouling layer on the membrane surface. However, the fouling layer was effectively cleaned during the photocatalytic self-cleaning and found to be attached reversibly to a membrane surface which was washed during the cleaning cycles of the membrane. The second cycle of O/W separation evidenced that the membrane was able to recover >95% of its original permeate flux. At the same time, the membrane followed nearly the same trend of fouling which was observed during the first cycle, as shown in FIG. 11A. Therefore, the super hydrophilic and underwater super-oleophobic membrane surface is desirable as the aforementioned characteristics may reduce the chances of permanent binding of the foulants to the membrane surface. The photocatalytic properties of the membrane permit a facile removal of foulants, such as oil droplets, therefrom. The separation efficiency of the membrane stayed at >99% for the duration of membrane testing, as shown in FIG. 10B. Hence, the significance of covalently cross-linking the components in the active layer of the membrane, such as EDA, F—SrTiO₃ and IPC reacted through interfacial polymerization to yield a stable and efficient active layer responsible for the separation of O/W emulsion at 200 ppm, was highlighted.

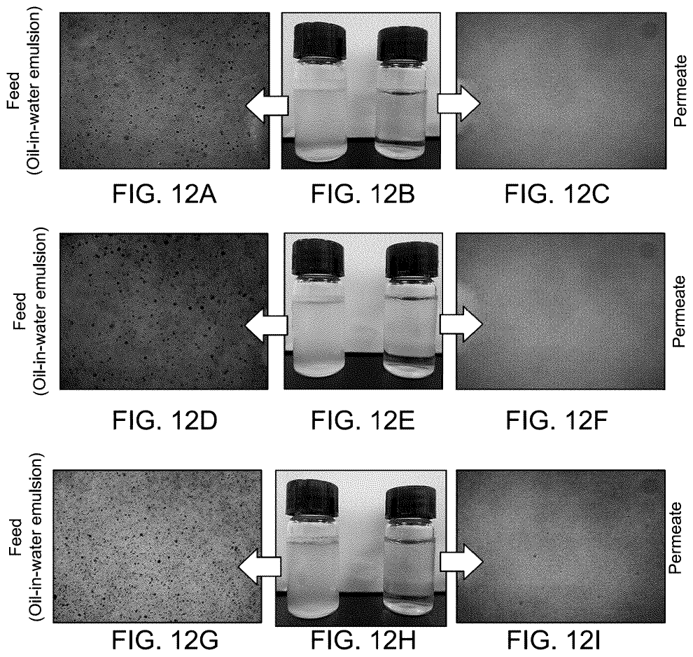

Referring to FIGS. 12A-12I provide examples of experimental samples collected during oil-in-water (O/W) separation experiments. For the feeds including 50 ppm (FIG. 12A), 100 ppm (FIG. 12D), and 200 ppm (FIG. 12G) of oil, the droplets can be seen in the optical images as being dispersed throughout the feed in case of all the aforementioned feed types. The concentration of the oil droplets increases from the lower to higher concentrations of oil emulsified in the feed. The feed samples were collected for 50 ppm (FIG. 12B), 100 ppm (FIG. 12E), and 200 ppm (FIG. 12H) oil content and it may be concluded that the turbidity increases with increasing oil concentration. However, for the permeates collected during filtration conditions, the samples appeared to have a complete removal of turbidity, further confirmed by optical images of the permeates of 50 ppm sample, 100 ppm sample, and 200 ppm sample shown in FIG. 12C, FIG. 12F, and FIG. 12I, respectively. The aforementioned observations for the experimental samples of the feed and the permeates thereof confirmed the separation of O/W emulsion using F—SrTiO₃/PA@PVDF membrane.

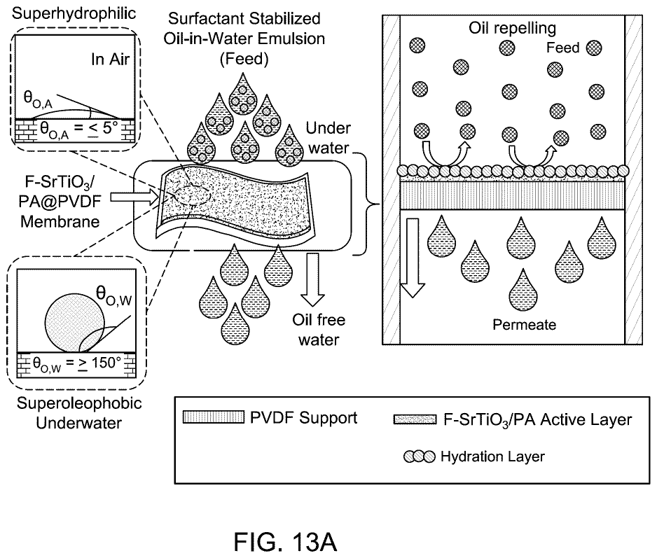

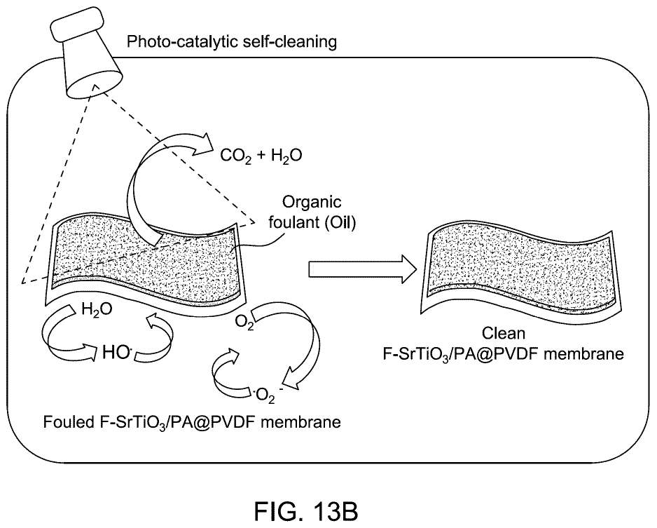

The above experimental observations regarding O/W separation may be explained by considering the exemplary separation mechanisms depicted in FIG. 13A. The hydrophilic and underwater super-oleophobic surfaces may develop a strong hydration layer on the top of the membrane surface which lowers the ability of the dissolved oil to stick to the membrane. The hydration layer has an opposite chemical nature compared to the oil. Hence, the membrane allows the water to permeate whereas oil is prohibited. However, the fouling tendency still exists during O/W separation experiments which may be attributed to the fact that, in the oil-in-water emulsions, the hydrophilic components lie toward the surface of the micelles which brings the emulsified oil droplets closer to the membrane surface leading to fouling of the membrane. The photocatalytic self-cleaning properties of the membrane result in removing the foulants attached to the membrane surface owing to the photocatalytic potential of SrTiO₃, as shown in FIG. 13B. The oxidation-reduction reactions during photocatalysis may generate a superoxide radical which oxidizes the oil, converting it into CO₂ and H₂O.

The aspects of the present disclosure provide an ultrafiltration membrane, a method of production thereof and a method separating oil-in-water (O/W) emulsions using the ultrafiltration membrane prepared herein. In particular, the present disclosure provides for the fabrication of the perovskite-structured SrTiO₃ ceramic nanoparticles decorated photo-active membrane, wherein the perovskite-structured ceramic SrTiO₃ nanoparticles were purposely functionalized by an aminosilane for the sake of introducing —NH₂ reactive groups on the SrTiO₃ leading to functionalized F—SrTiO₃ nanoparticles. The nanoparticles were further decorated in the membrane active layer by interfacial polymerization (IP), wherein a bifunctional acid chloride such as isophthaloyl chloride (IPC) was used as a crosslinker to bind the SrTiO₃ nanoparticles in the active layer. Furthermore, an external diamine, such as the ethylene diamine (EDA), was used as an external amine to develop a uniform and stable hybrid polyamide active layer on a PVDF support. The obtained F—SrTiO₃/PA@PVDF membrane showed desirable performance in terms of separation efficiency, which was determined to be >99% for the feeds containing different amounts of the oil in water such as 50 ppm, 100 ppm, and 200 ppm. In addition, the permeate flux of the F—SrTiO₃/PA@PVDF membrane was found to be 310 L m⁻h⁻¹ at a transmembrane pressure of 2 bar (0.2 MPa). The stability and recycling experiments revealed that the F—SrTiO₃/PA@PVDF membrane had a stable rejection of >99% for a feed having an oil content of 200 ppm. The self-cleaning properties of the perovskite-structured SrTiO₃ resulted in restoring the separation potential of the membrane following the fouling phase.

Therefore, the methods as described herein, for developing photocatalytic self-cleaning hybrid polymeric-inorganic membranes has been proven to be advantageous in developing membranes for treating oily wastewater. The present disclosure may allow the utilization of properties of inorganic hydrophilic materials to be covalently incorporated in the active layer to make the membrane super hydrophilic, underwater super-oleophobic, and to demonstrate photocatalysis.

Numerous modifications and variations of the present disclosure are possible in light of the above teachings. It is therefore to be understood that within the scope of the appended claims, the invention may be practiced otherwise than as specifically described herein.

1. An ultrafiltration membrane comprising:
a microporous support layer comprising polyvinylidene fluoride; and,
an active layer disposed on and in the support layer, the active layer comprising a polyamide matrix in which are dispersed nanoparticles of strontium titanate (SrTiO₃) which have been functionalized with an amino-functional alkoxysilane,
wherein the nanoparticles of strontium titanate are covalently bonded to the polyamide matrix, and
wherein the polyamide matrix is obtained by the polycondensation reaction of a C₂-C₆ alkylene diamine and an aromatic dicarboxylic acid or a reactive derivative thereof.

2. The ultrafiltration membrane according to claim 1, wherein the active layer wholly covers the microporous support layer.

3. The ultrafiltration membrane according to claim 1 comprising agglomerates of rounded functionalized nanoparticles of strontium titanate (SrTiO₃).

4. The ultrafiltration membrane according to claim 1, wherein at least a fraction of the nanoparticles of strontium titanate (SrTiO₃) are uniformly functionalized across their surfaces by the amino-functional alkoxysilane, as demonstrated by energy-dispersive X-ray spectroscopy (EDS).

5. The ultrafiltration membrane according to claim 1, wherein the nanoparticles of strontium titanate (SrTiO₃) have a median volume particle size (Dv50) of from about 20 to about 100 nm, as determined by transmission electron microscopy (TEM).

6. The ultrafiltration membrane according to claim 1, wherein the nanoparticles of strontium titanate (SrTiO₃) have a median volume particle size (Dv50) of from about 40 to about 60 nm, as determined by transmission electron microscopy.

7. The ultrafiltration membrane according to claim 1, wherein the amino-functional alkoxysilane has the general formula:
$$( {R}^{4} ) ( H ) N - {R}^{3} - {Si ( {R}^{2} )}_{3 - b} {( {R}^{1} )}_{b}$$
wherein: R¹ is C₁-C₆ alkyl; R² is C₁-C₆ alkyl; R³ is C₁-C₁₂ alkylene; R⁴ is H or C₁-C₆ alkyl; and b is 1, 2 or 3.

8. The ultrafiltration membrane according to claim 7, wherein: R¹ is C₁-C₂ alkyl; R² is C₁-C₂ alkyl; R³ is C₁-C₄ alkylene; R⁴ is H; and b is 2 or 3.

9. The ultrafiltration membrane according to claim 7, wherein the amino-functional alkoxysilane is selected from the group consisting of: 3-aminopropyltrimethoxysilane; 3-aminopropyltriethoxysilane; 3-aminopropyldimethoxymethylsilane; and, 3-aminopropyldimethoxymethylsilane.

10. The ultrafiltration membrane according to claim 1, wherein the polyamide matrix is obtained by the polycondensation reaction of a C₂-C₆ alkylene diamine with isophthalic acid, terephthalic acid or a reactive derivative thereof.

11. The ultrafiltration membrane according to claim 1, wherein the polyamide matrix is obtained by the polycondensation reaction of a C₂-C₄ alkylene diamine with isophthalic acid, terephthalic acid or a reactive derivative thereof.

12. The ultrafiltration membrane according to claim 1, wherein the polyamide matrix is obtained by the polycondensation reaction of ethylene diamine with isophthalic acid or a reactive derivative thereof.

13. The ultrafiltration membrane according to claim 1 having:
a water contact angle in air (θ_{W,A}) of from about 65 to about 75°;
an oil contact angle in air (θ_{O,A}) of from about 0 to about 10°; and,
an oil contact angle in water (θ_{O,W}) of from 155° to 165°.

14. The ultrafiltration membrane according to claim 1, having a flux of at least 50 Lm⁻²h⁻¹ as determined at about 100 kPa and about 25° C. in accordance with ASTM D5090-20.

15. The ultrafiltration membrane according to claim 1, having a flux of from about 50 to about 400 Lm⁻²h⁻¹ as determined at about 200 kPa and about 25° C. in accordance with ASTM D5090-20.

16. A method of preparing the ultrafiltration membrane as defined in claim 1, said method comprising the steps of:
contacting for a duration of from about 10 to about 100 hours the amino-functional alkoxysilane with a dispersion of SrTiO₃ nanoparticles in a polar protic solvent;
separating the SrTiO₃ nanoparticles functionalized with said amino-functional alkoxysilane from the dispersion; and,
forming the polyamide matrix by the polycondensation reaction of the C₂-C₆ alkylene diamine and the aromatic dicarboxylic acid or reactive derivative thereof, wherein the polycondensation reaction is performed in the presence of the functionalized SrTiO₃ nanoparticles and at an interfacial surface of the microporous support layer comprising polyvinylidene fluoride.

17. The method according to claim 16 further comprising, prior to the condensation reaction:
impregnating the microporous support layer comprising polyvinylidene fluoride with a fraction of the reactant C₂-C₆ alkylene diamine; and,
disposing at least a fraction of the functionalized SrTiO₃ nanoparticles on the interfacial surface of the microporous support layer comprising polyvinylidene fluoride.

18. An ultrafiltration method comprising:
flowing an oil-in-water emulsion through the ultrafiltration membrane as defined in claim 1; and,
collecting the permeate.

19. The method according to claim 18, wherein the oil-in-water emulsion comprises from about 10 to about 250 parts per million by weight of oil.

20. The method according to claim 18, in which there is a transmembrane pressure differential of from about 50 to about 200 kPa.
